(19) United States
(12) Patent Application Publication
(10) Pub. No.: US 2026/0334378 A1
(43) Pub. Date: Oct. 29, 2026

(54) PLANT CULTIVATION METHOD AND PLANT-VITALIZING AGENT

(71) Applicant: Resonac Corporation, Tokyo (JP)

(72) Inventors: Makoto SAITO, Tokyo (JP); Hiroshi UCHIDA, Tokyo (JP); Ichiro FUJITA, Tokyo (JP); Naoyuki SUGAWARA, Tokyo (JP); Yoshio FUJIWARA, Tokyo (JP); Manabu KUWAJIMA, Tokyo (JP); Hisashi KIMOTO, Tokyo (JP)

(73) Assignee: Resonac Corporation, Tokyo (JP)

(21) Appl. No.: 19/675,704

(22) Filed: May 13, 2026

Related U.S. Application Data
(62) Division of application No. 18/013,442, filed on Jun. 29, 2021.

(30) Foreign Application Priority Data
Jun. 29, 2020 (JP) 2020-111733
Jun. 29, 2020 (JP) 2020-111773
Jun. 29, 2020 (JP) 2020-111793
Jun. 29, 2020 (JP) 2020-111838

(51) Int. Cl. A01G 7/06; A01G 22/05; A01G 22/25; A01G 22/40; A01G 22/55; A01N 43/16; A01P 21/00

(52) U.S. Cl. CPC A01G 7/06; A01G 22/05; A01G 22/25; A01G 22/40; A01G 22/55; A01N 43/16; A01P 21/00

(57) ABSTRACT

Provided is a method for improving the yield of a harvested product of at least one plant selected from the group consisting of plants belonging to the families Solanaceae, Cucurbitaceae, Poaceae and Fabaceae. A method for cultivating at least one plant selected from the group consisting of plants belonging to the families Solanaceae, Cucurbitaceae, Poaceae and Fabaceae comprises applying a plant-vitalizing agent comprising an exogenous elicitor and an endogenous elicitor to a young seedling of the plant at least one time.

### CROSS REFERENCE TO RELATED APPLICATIONS

This application is a divisional of U.S. application Ser. No. 18/013,442 filed Dec. 28, 2021, which is a National Stage of International Application No. PCT/JP2021/024616 filed Jun. 29, 2021, claiming priority based on Japanese Patent Application No. 2020-111773, Japanese Patent Application No. 2020-111793, Japanese Patent Application No. 2020-111838, and Japanese Patent Application No. 2020-111733 filed Jun. 29, 2020, respectively.

### FIELD

The present invention relates to a method for cultivating at least one plant selected from the group consisting of plants of the families Solanaceae, Cucurbitaceae, Poaceae and Fabaceae using an exogenous elicitor and an endogenous elicitor, and to a plant-vitalizing agent for cultivation of at least one plant selected from the group consisting of plants of the families Solanaceae, Cucurbitaceae, Poaceae and Fabaceae.

### BACKGROUND

Plants suffer reduction in yields due to abiotic stress as a result of daylight exposure time, atmospheric temperature and rainfall, and biological stress such as pests. In the case of Solanaceae plants, for example, a high level of solar radiation is desirable, the optimum temperature being 23 to 28 °C (for tomatoes, for example) or 18 to 20 °C (for potatoes, for example) during daytime, or near 10 to 15 °C at nighttime. In the case of tomato, exceeding this range may result in lengthening or poor fruit development, or in the case of potato, it may result in stunted growth of the tuber (potato). Excessive humidity conditions can also tend to cause problems such as lengthening, disease, or potato tuber rotting. In the case of Cucurbitaceae plants, a high level of solar radiation is also desirable, the optimum temperature being 25 to 30 °C during daytime, or near 12 to 20 °C at nighttime. The optimum soil pH is 6.0 to 6.5, and an environment with good water retention and drainage is desirable. Problems such as lengthening, poor fruit development or disease may occur when these conditions are not met. In the case of rice, a high level of solar radiation is desirable, the optimum temperature being 25 to 30 °C during daytime or near 14 to 18 °C at nighttime, with poor growth or reduced yields tending to be seen with temperatures outside of these ranges. During periods of prolonged lack of soil moisture such as drought, other problems can occur including reduced panicle count or poor fertilization resulting in lower yield, or pest damage. In the case of wheat, the cultivation conditions are set for a monthly average of about 14 °C as the atmospheric temperature during the raising period or a monthly average of about 20 °C during the mature phase before harvesting, and with annual precipitation of about 500 to 750 mm, since problems such as yield and quality reduction occur outside of these ranges. In the case of Fabaceae plants, a high level of solar radiation is desirable, the optimum temperature being 20 to 30 °C during daytime or near 13 to 18 °C at nighttime, with reduced dry weights tending to be seen at temperatures outside of these ranges. The optimal soil moisture is near 70 to 90%, and prolonged excessive humidity conditions tend to result in problems such as poor root growth and susceptibility to insect damage. With insufficient soil moisture, the numbers of branches and opening flowers are reduced and harvest yields are lowered. Various types of fertilizers and agricultural chemicals have been used in the prior art to increase yields, especially of agricultural crops. Fertilizers are used as nutrients required for plant growth, but they lack functions for alleviating stress. Agricultural chemicals directly eliminate pests that parasitize plants and thus eliminate biological stress, but the safety of using agricultural chemicals has not been adequately confirmed, and concerns remain regarding the effects of their excess consumption on the human body and on the environment, while chemical agents such as agricultural chemicals produced by chemical synthesis methods are also especially concerning in terms of their dispersion and residence for long periods in soil, for which reasons other methods are desired to provide resistance against biological stress. In recent years, the use of biostimulants has become a subject of interest in light of their safety for the human body and the environment.

The term “biostimulant”, sometimes synonymous with “plant-vitalizing agent”, refers to a component that contains a substance group or microorganism and, when applied to the plant body or its root system, stimulates the series of processes that take place in the plant body in its natural state, thereby improving nutrient absorption, increasing fertilization efficiency, providing stress resistance and improving quality, while also lacking any direct effect against pests so that it is not classified as an insecticide or microbicide. In other words, it is a component found in the natural world (including microorganisms), being a substance which is not a plant hormone or nutrient but which, even in small amounts, stimulates plant activity and promotes growth. Applying a biostimulant to a plant increases nutrient absorption and nutrient utilization in the plant, promoting its growth and improving the yield and quality of crops. Agricultural biostimulants include various formulations such as compounds, substances or other products that act on plants or soil to regulate and reinforce physiological processes in crops. Biostimulants act on plant physiology by a different route than that of nutrients to improve crop vitality, yield, quality and post-harvesting storage life.

Biostimulants can therefore stimulate the innate abilities of plants and promote their growth without causing problems associated with conventional agricultural chemicals or fertilizers.

Previous publications related to such biostimulants have contained descriptions of: plant-vitalizing agents that combine chitin oligosaccharides with chitosan which exhibits antimicrobial activity (PTL 1), plant-vitalizing agents combining oligosaccharides and plant extract components in vinegar (PTL 2), plant growth accelerators that include cellulose (PTL 3), plant growth regulators that include hexofuranose derivatives (PTL 4), a method of increasing plant disease resistance using low molecularized chitin or chitosan (PTL 5), and fertilizers containing chitin and/or chitosan (PTL 6).

### CITATION LIST

### Patent Literature

[PTL 1] Japanese Unexamined Patent Publication HEI No. 9-143013
[PTL 2] Japanese Unexamined Patent Publication No. 2001-64112
[PTL 3] Japanese Unexamined Patent Publication No. 2002-114610
[PTL 4] Japanese Unexamined Patent Publication No. 2013-151438
[PTL 5] Japanese Unexamined Patent Publication No. 2015-48436
[PTL 6] Japanese Unexamined Patent Publication No. 2017-95352
[PTL 7] International Patent Publication No. WO2017/104687

### SUMMARY

### Technical Problem

Despite the above, no studies have been conducted in regarding to adjusting the manner in which plant-vitalizing agents are provided for different plant varieties during cultivation of plants in order to increase their effects. In particular, the concept of using plant-vitalizing agents suitable for at least one plant selected from the group consisting of plants of the families Solanaceae, Cucurbitaceae, Poaceae and Fabaceae has not been known.

### Solution to Problem

The present invention has been devised in light of the situation described above, on the basis of much diligent research regarding the use of plant-vitalizing agents for cultivation of at least one plant selected from the group consisting of plants of the families Solanaceae, Cucurbitaceae, Poaceae and Fabaceae. As a result, it was found that harvest yields are markedly increased if a plant-vitalizing agent comprising an exogenous elicitor and an endogenous elicitor is applied to seedlings of at least one plant selected from the group consisting of plants of the families Solanaceae, Cucurbitaceae, Poaceae and Fabaceae, and the invention was thus completed.

Specifically, the present invention encompasses the following [1] to [20].

[1] A method for cultivating at least one plant selected from the group consisting of plants of the families Solanaceae, Cucurbitaceae, Poaceae and Fabaceae, wherein the method comprises applying a plant-vitalizing agent comprising an exogenous elicitor and an endogenous elicitor at least once to a seedling of the plant.

[2] The method for cultivating a plant according to [1], wherein the exogenous elicitor is a chitin oligosaccharide, and the endogenous elicitor is at least one type of oligosaccharide selected from among cellooligosaccharides and xylooligosaccharides.

[3] The method for cultivating a plant according to [1] or [2], wherein the mass ratio of the exogenous elicitor with respect to the endogenous elicitor in the plant-vitalizing agent is 0.1 to 5.

[4] The method for cultivating a plant according to any one of [1] to [3], which comprises a xylooligosaccharide as the endogenous elicitor.

[5] The method for cultivating a plant according to [4], which comprises both a cellooligosaccharide and a xylooligosaccharide as the endogenous elicitor.

[6] The method for cultivating a plant according to [5], wherein the mass ratio of the cellooligosaccharide with respect to the xylooligosaccharide in the plant-vitalizing agent is 0.2 to 5.

[7] The method for cultivating a plant according to any one of [1] to [6], wherein the method comprises applying a plant-vitalizing agent to a seedling of the plant at least once at 2 to 15 days after germination.

[8] The method for cultivating a plant according to any one of [1] to [7], wherein the method comprises applying a plant-vitalizing agent to a plant body at least once after the seedling stage.

[9] The method for cultivating a plant according to any one of [1] to [8], wherein the plant is a Solanaceae plant.

[10] The method for cultivating a plant according to [9], wherein the Solanaceae plant is at least one selected from the group consisting of tomato, potato and bell pepper.

[11] The method for cultivating a plant according to any one of [1] to [8], wherein the plant is a Cucurbitaceae plant.

[12] The method for cultivating a plant according to [11], wherein the Cucurbitaceae plant is at least one selected from the group consisting of watermelon and cucumber.

[13] The method for cultivating a plant according to any one of [9] to [12], wherein the seedling is a scion for grafted seedling growth.

[14] The method for cultivating a plant according to any one of [1] to [8], wherein the plant is a Poaceae plant.

[15] The method for cultivating a plant according to [14], wherein the Poaceae plant is at least one selected from the group consisting of rice, wheat, barley, corn and sugarcane.

[16] The method for cultivating a plant according to any one of [1] to [8], wherein the plant is a Fabaceae plant.

[17] The method for cultivating a plant according to [16], wherein the Fabaceae plant is at least one selected from the group consisting of soybean and azuki bean.

[18] The method for cultivating a plant according to any one of [1] to [17], which comprises applying the plant-vitalizing agent to a plant at a concentration so that the total content of the exogenous elicitor and the endogenous elicitor is 0.1 to 500 ppm by mass.

[19] The method for cultivating a plant according to any one of [1] to [18], which comprises applying the plant-vitalizing agent to a plant by foliar application.

[20] A plant-vitalizing agent comprising an exogenous elicitor and an endogenous elicitor, to be used for cultivation of at least one plant selected from the group consisting of plants of the families Solanaceae, Cucurbitaceae, Poaceae and Fabaceae, which is applied at least one time to a seedling of the plant.

### Advantageous Effects of Invention

The method for cultivating at least one plant selected from the group consisting of plants of the families Solanaceae, Cucurbitaceae, Poaceae and Fabaceae according to the invention can increase harvest yields by application of a plant-vitalizing agent comprising an exogenous elicitor and an endogenous elicitor to a seedling of at least one plant selected from the group consisting of plants of the families Solanaceae, Cucurbitaceae, Poaceae and Fabaceae.

### DESCRIPTION OF EMBODIMENTS

Embodiments of the invention will now be explained. The following embodiments are merely examples of the invention and are not intended to be limitative in any way.

The method for cultivating at least one plant selected from the group consisting of plants of the families Solanaceae, Cucurbitaceae, Poaceae and Fabaceae according to the embodiment comprises applying a plant-vitalizing agent comprising an exogenous elicitor and an endogenous elicitor to a seedling of at least one plant selected from the group consisting of plants of the families Solanaceae, Cucurbitaceae, Poaceae and Fabaceae. The term “plant-vitalizing agent” includes not only substances that have effects of alleviating abiotic stresses such as temperature, light, water and salts that are involved in the growth of plants, but also effects of alleviating biological stresses such as pests.

The term “elicitor” generally refers to a substance that induces a biological defense reaction in a higher plant tissue or cultured cells, whereby it induces disease resistance by plant immunomechanisms. Plants are sensitive to elicitors by receptors present on leaf surfaces, initiating pathogen resistance reactions. This induces biological defense activity (immunity) in which various compounds are secreted against different pathogenic organisms. When an elicitor acts on a plant, it induces defense reactions such as synthesis and accumulation of phytoalexins and infection-specific proteins, production of active oxygen species, production of active nitrogen species, hypersensitive reactive cell death, and changes in gene expression, these reactions being thought to protect the plant from pathogenic organisms and increase disease resistance.

Phytoalexins are antimicrobial compounds synthesized and accumulated in the plant body due to action of elicitors, and the antimicrobial compounds produced differ depending on the plant variety. Typical phytoalexins include flavonoids, terpenoids and fatty acid derivatives. Active oxygen species kill pathogenic microorganisms, while active oxygen and active nitrogen species, either alone or in coordination, also function as signals to initiate various defense reactions. The disease resistance provided by such elicitor effects helps to augment resistance against a wide range of diseases, and it is therefore expected to be useful for agriculture.

### [Exogenous Elicitor]

As used herein, “exogenous elicitor” means an elicitor which is a substance derived from an organism other than the plant, such as a fungus, insect or crustacean, and while it is not particularly restricted other than having an elicitor effect, it will typically be chitin, chitosan or one of their oligosaccharides, or insect-derived biomolecules.

The plant-vitalizing agent to be used in the method for cultivating at least one plant selected from the group consisting of plants of the families Solanaceae, Cucurbitaceae, Poaceae and Fabaceae preferably includes a chitin oligosaccharide as an exogenous elicitor.

Chitin oligosaccharides contain partially deacetylated chitosan oligosaccharides, being oligosaccharides with several N-acetylglucosamines linked together which can generally be obtained by hydrolysis of crustacean-derived chitins, and they are also known as oligo-N-acetylglucosamines.

Specifically, chitin oligosaccharides are obtained by chemical or enzymatic partial hydrolysis of chitin prepared by a common method from shells of crustaceans such as crab or shrimp. A chitin oligosaccharide that is used is preferably one or a mixture of more than one selected from among N-acetylchitobiose, N-acetylchitotriose, N-acetylchitotetraose, N-acetylchitopentaose, N-acetylchitohexaose, N-acetylchitoheptaose and N-acetylchitooctaose. Among these, N-acetylchitopentaose, N-acetylchitohexaose and N-acetylchitoheptaose have particularly high elicitor effects.

Chitin oligosaccharides to be used for the embodiment are most preferably ones having the following chemical structure.

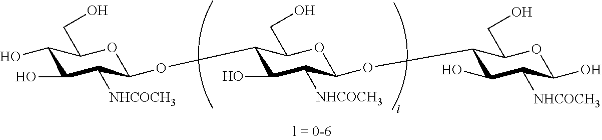

These include compounds wherein some of the acetyl groups (—COCH₃) in the formula are shed, converting —NHCOCH₃ to —NH₂ groups.

### [Endogenous Elicitor]

As used herein, “endogenous elicitor” means a plant-derived elicitor, with no particular restrictions other than having an elicitor effect, but typically it will be a cellulose or xylan produced from a plant, or an oligosaccharide of the same.

The plant-vitalizing agent to be used in the method for cultivating at least one plant selected from the group consisting of plants of the families Solanaceae, Cucurbitaceae, Poaceae and Fabaceae according to the embodiment preferably includes at least one oligosaccharide selected from among cellooligosaccharides and xylooligosaccharides as an endogenous elicitor.

Cellooligosaccharides are oligosaccharides polymerized by β-glycoside bonding of multiple glucose molecules, and in recent years they have been found to have functionality including moisture retention, stickiness inhibition, freshness functionality, starch aging reduction and protein denaturation inhibition, for which they are expected to have uses in the fields of medicine, cosmetics, foods and feed. In particular, cellooligosaccharides with a glucose polymerization degree of 3 or greater are even more promising in terms of increasing the functionality mentioned above and also providing new functionality. The cellooligosaccharides currently used in industry are produced by enzyme reaction, but their main components are glucose and dimeric cellobioses, whereas they contain almost no trimeric cellotriose or greater oligomers. In recent years, however, the present applicants have reported a method for producing cellooligosaccharides that comprise oligomers with a glucose polymerization degree of 3 to 6, in hydrolysis reaction of vegetable biomass using a carbon catalyst, by carrying out hydrothermal reaction while controlling the temperature-elevating rate, cooling rate, reaction temperature and reaction time (PTL 7).

Cellooligosaccharides to be used for the embodiment are most preferably ones having the following chemical structure.

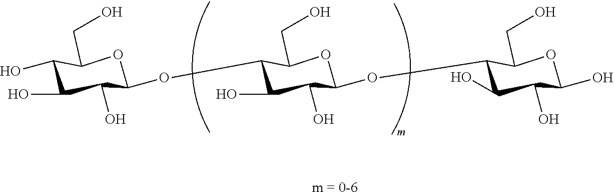

Xylooligosaccharides are oligosaccharides polymerized by β-glycoside bonding of multiple xylose molecules, and they are generally obtained by hydrolysis of xylan as the main component of hemicellulose, being marketed mainly for comestible purposes.

Xylooligosaccharides to be used for the embodiment are most preferably ones having the following chemical structure.

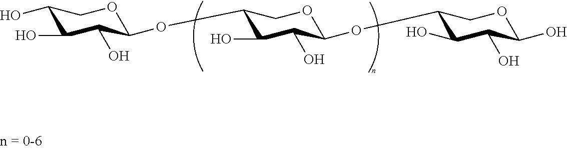

### [Plant-Vitalizing Agent]

The plant-vitalizing agent to be used in the method for cultivating at least one plant selected from the group consisting of plants of the families Solanaceae, Cucurbitaceae, Poaceae and Fabaceae of the embodiment preferably includes at least the aforementioned exogenous elicitor and endogenous elicitor as active components. The mass ratio of the exogenous elicitor with respect to the endogenous elicitor in the plant-vitalizing agent (exogenous elicitor content/endogenous elicitor content) is preferably 0.1 to 5, more preferably 0.2 to 2 and even more preferably 0.3 to 0.6.

The plant-vitalizing agent more preferably comprises a xylooligosaccharide as the endogenous elicitor, and optimally it comprises both a cellooligosaccharide and a xylooligosaccharide. The mass ratio of the cellooligosaccharide with respect to the xylooligosaccharide in the plant-vitalizing agent (cellooligosaccharide content/xylooligosaccharide content) is preferably 0.2 to 5, more preferably 0.3 to 3 and even more preferably 0.4 to 1.2.

When the plant-vitalizing agent comprises a chitin oligosaccharide as the exogenous elicitor and both a cellooligosaccharide and a xylooligosaccharide as the endogenous elicitor, the percentage of each oligosaccharide with respect to the total content of the chitin oligosaccharide, cellooligosaccharide and xylooligosaccharide is preferably 10 to 50 mass % of the chitin oligosaccharide, 10 to 50 mass % of the cellooligosaccharide and 10 to 60 mass % of the xylooligosaccharide. The percentage of each oligosaccharide is more preferably 20 to 40 mass % of the chitin oligosaccharide, 20 to 40 mass % of the cellooligosaccharide and 20 to 55 mass % of the xylooligosaccharide.

The plant-vitalizing agent may also contain components other than the exogenous elicitor and endogenous elicitor as active components, such as antiseptic agents, spreading agents, anti-settling agents, thickeners, fillers and solvents. Antiseptic agents include potassium sorbate, paraoxybenzoic acid esters, benzoin, sodium dehydroacetate, hinokitiol, phenoxyethanol, polyaminopropyl biguanide and polylysine. Spreading agents are viscous liquids composed mainly of surfactants, and they are not particularly restricted so long as they can be used as spreading agents for plant-vitalizing agents, examples including polyoxyethylene nonylphenyl ethers, sorbitan fatty acid esters and polyoxyethylene hexitan fatty acid esters. Anti-settling agents include polyphosphoric acid and polyphosphoric acid salts, or polycarboxylic acid-type polymer surfactants. Thickeners include carboxymethyl cellulose (CMC), polyacrylamide, water-soluble polymers such as starch, or molasses, alcohol fermentation concentrate waste liquids and amino acid fermentation concentrate waste liquids. Fillers include lactose and starch. A solvent is used for the purpose of diluting the active component to a suitable liquid concentration, or to facilitate dispersion onto plants. Water is preferred as the solvent.

The plant-vitalizing agent to be used in the method for cultivating at least one plant selected from the group consisting of plants of the families Solanaceae, Cucurbitaceae, Poaceae and Fabaceae of the embodiment may be in a powder, granular or liquid form, but it is generally preferred to be liquid to facilitate dispersion. When a liquid plant-vitalizing agent is to be used, the active component concentration in the plant-vitalizing agent during dispersion onto a plant is preferably 0.1 to 500 ppm by mass, more preferably 0.5 to 200 ppm by mass and even more preferably 1 to 100 ppm by mass. The active component concentration in the plant-vitalizing agent is the total content of the exogenous elicitor and endogenous elicitor in the plant-vitalizing agent. If the dispersion concentration is 0.1 ppm by mass or greater the effect as a plant-vitalizing agent will be exhibited more effectively. If the dispersion concentration is 500 ppm by mass or lower it will be possible for disease resistance to be exhibited without inhibiting growth of the plant.

The plant-vitalizing agent used may be a commercially available product with the active component concentration already prepared to the specified concentration, but in most cases a stock solution of the plant-vitalizing agent comprising the exogenous elicitor and endogenous elicitor at high concentration will be used by dilution with water. When the plant-vitalizing agent stock solution is used as a dilution (such as a 1000× dilution), the total content of the exogenous elicitor and endogenous elicitor in the plant-vitalizing agent stock solution is preferably 0.05 to 10 mass %, more preferably 0.1 to 8 mass % and even more preferably 0.5 to 6 mass %.

### [Solanaceae Plants]

The type of Solanaceae plant to be cultivated by the cultivation method of the embodiment is not particularly restricted, and plants belonging to the genus Solanum, Capsicum, Nicotiana, Datura or Physalis may be mentioned.

Specifically these include Solanum plants such as tomato, mini tomato, eggplant and potato, Capsicum plants such as bell pepper, paprika, shishito and hot pepper, Nicotiana plants such as tobacco, and Physalis plants such as Chinese lantern plant. Preferred are Solanum plants such as tomato, eggplant, bell pepper and potato, among which tomato, potato and bell pepper are more preferred.

### [Cucurbitaceae Plants]

The type of Cucurbitaceae plant to be cultivated by the cultivation method of the embodiment is not particularly restricted, and plants belonging to the genus Citrullus, Cucurbita, Cucumis, Lagenaria, Momordica or Benincasa may be mentioned.

Specifically, these include Citrullus plants such as watermelon, Cucurbita plants such as pumpkin and zucchini, Cucumis plants such as cucumber and melon, Lagenaria plants such as bottle gourd and gourd, Momordica plants such as nigauri and goya, and Benincasa plants such as white gourd.

Preferred among these are Citrullus plants such as watermelon and Cucumis plants such as cucumber and melon, with watermelon, cucumber and melon being more preferred.

### [Poaceae Plants]

The type of Poaceae plant to be cultivated by the cultivation method of the embodiment is not particularly restricted, and plants belonging to the genus Oryza, Triticum, Hordeum, Zea or Saccharum may be mentioned. Preferred among these are Oryza, Triticum, Zea and Saccharum, with Oryza, Triticum and Zea being especially preferred.

Rice is an example of an Oryza plant, with varieties including Japonica, Indica and Japanica, which are classified according to starch type or cultivation form, such as non-glutinous rice, glutinous rice, upland non-glutinous rice or upland glutinous rice, and also sometimes falling under other classifications such as ancient rice, for example. Preferred cultivar classifications are Japonica and Indica, and non-glutinous rice is the preferred starch type classification.

Wheat is an example of a Triticum plant, which is classified by its cultivation form as spring wheat or autumn wheat. Classifications according to use include hard wheat used mainly in bread and Chinese noodles, intermediate wheat used mainly in Japanese noodles (such as udon), soft wheat used mainly in confectioneries and cooking, and durum wheat used mainly in pasta.

Barley is an example of a Hordeum plant, which is classified based on differences in ear shape, into two-row barley, four-rowed barley, six-rowed barley, naked barley or wild barley. Two-row barley and six-rowed barley are preferred among these.

Corn is an example of a Zea plant, which is classified as sweet corn used mainly in foods, hard corn used mainly in non-food feeds, popcorn used mainly as a confectionery, waxy corn soft corn and giant corn used mainly in processed foods, and dent corn used mainly for feed or industrial use (such as ethanol production). Sweet corn, hard corn and dent corn are preferred among these.

Sugarcane is an example of a Saccharum plant, which is classified as early sugarcane, middle sugarcane or and late sugarcane.

### [Fabaceae Plants]

The type of Fabaceae plant cultivated by the cultivation method of the embodiment is not particularly restricted, but plants belonging to the genus Phaseolus, Pisum, Vigna, Vicia, Glycine or Arachis may be mentioned.

Specifically, these include Phaseolus plants such as kidney bean and quail bean, Pisum plants such as peas, Vigna plants such as adzuki bean and cowpea, Vicia plants such as horse-bean, Glycine plants such as edamame and soybean, and Arachis plants such as peanut.

Preferred among these are Glycine plants such as soybean and edamame, with soybean being more preferred.

### [Cultivation Method]

### (Method for Cultivating Solanaceae Plants)

The cultivation form of a Solanaceae plant is not particularly restricted, and it may be outdoor cultivated, greenhouse cultivated or hydroponically cultivated. For cultivation of a Solanaceae plant it is important to prepare full seedlings in order to ensure high quality fruit or tuber production and high yield. In the case of tomato, the seeds may be directly sowed in the field, or seeding and raising of seedlings may be divided in order to prepare full seedlings, with field planting of the raised seedlings. In the case of potato, seed potato may be directly planted into the field, or the seed potato planting and raising of seedlings may be divided, with subsequent field planting of the raised seedlings.

When seeding and raising of seedlings are divided, the following is one possible method for tomatoes.

After placing in seeding soil in a nursery box and adequately irrigating, the seeding furrows may be cut and seeded at equal spacings. After soil covering, compaction and sufficient watering they are allowed to grow at 25 to 28 °C. During the initial raising period after germination, the soil moisture is preferably kept at a slight excess and then gradually reduced. It is preferred to add additional liquid fertilizer as appropriate during the latter stage of raising. Grafted seedlings may also be used as a measure against pest damage or continuous crop failure. A publicly known method may be used to raise the grafted seedlings.

For direct planting into the field, the following method may be employed, using potato as an example.

The field is preferably plowed to a depth of 25 to 30 cm for thorough drainage, with high ridges. Seed potatoes pre-sprouted under bath light are cut to sizes of about 40 to 60 g each for an even number of buds, plant ash is sprinkled in the cuts, and they are planted to a depth of about 10 cm with 20 to 50 cm between plants. In order to prevent rotting of the seed potatoes, it is preferred to avoid irrigation if the soil is wet. In the case of spring planting, preferably a black vinyl mulch is spread out as a frost protector and holes are opened at locations where buds will appear.

The method for cultivating Solanaceae plants of this embodiment includes applying the plant-vitalizing agent to seedlings. As used herein, “seedling” means seedlings from germination to planting when seeding (or planting of seed potatoes) and raising of seedlings are carried out separately, or when seeds are directly sowed in the field (or seed potatoes are planted), it means seedlings from germination until the 3rd week. When grafted seedlings are used for cultivation of plants as described below, “seedling” means the scion used to raise a grafted seedling.

According to one aspect, in order to obtain full seedlings, preferably the plant-vitalizing agent is used at least once for seedlings 2 to 15 days after germination, more preferably it is used at least once for seedlings at 2 to 10 days, and even more preferably it is used at least once for seedlings at 3 to 7 days. The number of times that the plant-vitalizing agent is used during the period of 2 to 15 days after germination is preferably 1 to 2 times and more preferably once.

According to another aspect, when seeding (or seed potato planting) and raising of seedlings are carried out separately, the agent is preferably used at least once for seedlings from 16 days after germination until planting. The number of times the plant-vitalizing agent is used during the period from 16 days after germination until planting will differ depending on the raising period, but it is preferably once during 5 days to 30 days, and more preferably once during 10 days to 20 days.

According to yet another aspect, when seeds are directly sowed in the field (or when seed potatoes are directly planted), the agent is preferably used at least once for seedlings from 16 days until 3 weeks after germination.

In order to obtain fuller seedlings, most preferably the plant-vitalizing agent is used at least once for seedlings 2 to 15 days after germination, and at least once for the seedlings thereafter, at a frequency of once during 5 days to 30 days.

In the method for cultivating Solanaceae plants of this embodiment, grafted seedlings may be used for cultivation of plants. When grafted seedlings are raised, seeding of rootstocks may also be carried out with the scions (seedlings), but in order to raise fuller grafted seedlings it is preferred to use the plant-vitalizing agent at least once during 2 to 15 days after germination of the rootstocks, even for rootstocks to be used for raising of grafted seedlings. The number of times that the plant-vitalizing agent is used for rootstocks during the period of 2 to 15 days after germination is preferably 1 to 2 times and more preferably once. When at least 1 week has passed from first use of the plant-vitalizing agent until grafting, it is preferably used once during 5 days to 30 days and more preferably once during 10 days to 20 days, during the period from first use until grafting, for scions and rootstocks. Grafting of the rootstocks and scions may be carried out by a common method in the field.

According to another aspect of the method for cultivating Solanaceae plants of this embodiment, the plant-vitalizing agent is preferably also applied to plant bodies after the seedling stage. As used herein, “plant body after the seedling stage” refers to a plant body that has passed the aforementioned “seedling” stage. Specifically, it refers to a plant body after planting when seeding (or planting of seed potatoes) and raising of seedlings are carried out separately, or when seeds are directly sowed in the field (or seed potatoes are planted), it refers to the plant body after the period from germination until the 3rd week has elapsed. When grafted seedlings are used for cultivation of a plant as described above, the “plant body after the seedling stage” refers to the grafted seedlings before planting and after planting (the seedlings after grafting of the rootstocks and scions).

When grafted seedlings are use for cultivation of plants, preferably the plant-vitalizing agent is also used at least once for the raised grafted seedlings from one week after grafting until before planting. The number of times the plant-vitalizing agent is used for grafted seedlings during the period from one week after grafting until before planting will differ depending on the raising period, but it is preferably once during 5 days to 30 days, and more preferably once during 10 days to 20 days.

In order to obtain fuller seedlings, the plant-vitalizing agent is most preferably used at least once for both scions (seedlings) and rootstocks at 2 to 15 days after germination, at least once to the scions (seedlings) and rootstocks thereafter at a frequency of one time during 5 days to 30 days, and at least once for grafted seedlings from one week after grafting until before planting.

According to one aspect, when seeding and raising of seedlings are carried out separately or grafted seedlings are used for cultivation of the plants, the planting may be carried out by a conventional agricultural method for each crop. In the case of tomato cultivation, for example, they are preferably carried out with seedlings that have begun to bloom their first flowers of the first corolla about 50 to 55 days after seeding. Planting is preferably non-dense shallow planting to ensure sunlight exposure, with post-planting irrigation to promote root taking. The method of applying the plant-vitalizing agent is preferably usage at least once to the plant bodies during 1 and 2 weeks after planting. Afterwards it is preferably used 2 to 10 times, once every one to two weeks.

According to yet another aspect, when seeds are directly sowed in the field (or when seed potatoes are directly planted), the plant-vitalizing agent is preferably used at least once for the plant bodies after 3 weeks have elapsed after germination. The frequency of use is preferably 2 to 10 times, once every one to two weeks.

### (Method for Cultivating Cucurbitaceae Plants)

The cultivation form of a Cucurbitaceae plant is not particularly restricted, and it may be outdoor cultivated, greenhouse cultivated or hydroponically cultivated. For cultivation of a Cucurbitaceae plant it is important to prepare full seedlings in order to ensure high quality fruit and high yield. The seeds may be directly sowed in the field, or seeding and raising of seedlings may be divided in order to prepare full seedlings, with field planting of the raised seedlings.

When seeding and raising of seedlings are divided, the following is one possible method as an example.

After placing in seeding soil in a nursery box and adequately irrigating, the seeding furrows may be cut and seeded at equal spacings. After soil covering, compaction and sufficient watering they are allowed to grow at 28 to 30 °C After germination, irrigation is preferably moderate in order to inhibit lengthening. It is preferred to add additional liquid fertilizer as appropriate during the latter stage of raising. Grafted seedlings may also be used as a measure against pest damage or continuous crop failure. A publicly known method may be used to raise the grafted seedlings.

The method for cultivating Cucurbitaceae plants of this embodiment includes applying the plant-vitalizing agent to seedlings. As used herein, “seedling” means seedlings from germination to planting when seeding and raising of seedlings are carried out separately, or when seeds are directly sowed in the field, it means seedlings from germination until the 3rd week. When grafted seedlings are used for cultivation of plants as described below, “seedling” means the scion used to raise a grafted seedling.

According to one aspect, in order to obtain full seedlings, preferably the plant-vitalizing agent is used at least once for seedlings 2 to 15 days after germination, more preferably it is used at least once for seedlings at 2 to 10 days, and even more preferably it is used at least once for seedlings at 3 to 7 days. The number of times that the plant-vitalizing agent is used during the period of 2 to 15 days after germination is preferably 1 to 2 times and more preferably once.

According to another aspect, when seeding and raising of seedlings are carried out separately, the agent is preferably used at least once for seedlings from 16 days after germination until planting. The number of times the plant-vitalizing agent is used during the period from 16 days after germination until planting will differ depending on the raising period, but it is preferably once during 5 days to 30 days, and more preferably once during 10 days to 20 days.

According to yet another aspect, when seeds are directly sowed in the field, the agent is preferably used at least once for seedlings from 16 days until 3 weeks after germination.

In order to obtain fuller seedlings, most preferably the plant-vitalizing agent is used at least once for seedlings 2 to 15 days after germination, and at least once for the seedlings thereafter, at a frequency of once during 5 days to 30 days.

In the method for cultivating Cucurbitaceae plants of this embodiment, grafted seedlings may be used for cultivation of the plants. When grafted seedlings are to be raised, seeding of rootstocks may also be carried out with the scions (seedlings), but in order to raise fuller grafted seedlings it is preferred to use the plant-vitalizing agent at least once during 2 to 15 days after germination of the rootstocks, even for rootstocks to be used for raising of grafted seedlings. The number of times that the plant-vitalizing agent is used for rootstocks during the period of 2 to 15 days after germination is preferably 1 to 2 times and more preferably once. When at least 1 week has passed from first use of the plant-vitalizing agent until grafting, it is preferably used once during 5 days to 30 days and more preferably once during 10 days to 20 days, during the period from first use until grafting, for scions and rootstocks. Grafting of the rootstocks and scions may be carried out by a common method in the field.

According to another aspect of the method for cultivating Cucurbitaceae plants of this embodiment, the plant-vitalizing agent is preferably also applied to plant bodies after the seedling stage. As used herein, “plant body after the seedling stage” refers to a plant body that has passed the aforementioned “seedling” stage. Specifically, it refers to a plant body after planting when seeding and raising of seedlings are carried out separately, or when seeds are directly sowed in the field, it refers to the plant body after the period from germination until the 3rd week has elapsed. When grafted seedlings are used for cultivation of a plant as described above, the “plant body after the seedling stage” refers to the grafted seedlings before planting and after planting (the seedlings after grafting of the rootstocks and scions).

When grafted seedlings are used for cultivation of plants, preferably the plant-vitalizing agent is also used at least once for the raised grafted seedlings from one week after grafting until before planting. The number of times the plant-vitalizing agent is used for grafted seedlings during the period from one week after grafting until before planting will differ depending on the raising period, but it is preferably once during 5 days to 30 days, and more preferably once during 10 days to 20 days.

In order to obtain fuller seedlings, the plant-vitalizing agent is most preferably used at least once for both scions (seedlings) and rootstocks at 2 to 15 days after germination, at least once to the scions (seedlings) and rootstocks thereafter at a frequency of one time during 5 days to 30 days, and at least once for grafted seedlings from one week after grafting until before planting.

According to one aspect, when seeding and raising of seedlings are carried out separately, or when grafted seedlings are used for cultivation of plants, planting is preferably carried out with seedlings having development of 4 or 5 true leaves at about 35 to 45 days after seeding. Planting is preferably non-dense shallow planting to ensure sunlight exposure, with post-planting irrigation to promote root taking. The method of applying the plant-vitalizing agent is preferably usage at least once to the plant bodies during 1 and 2 weeks after planting. Afterwards it is preferably used 2 to 10 times, once every one to two weeks.

According to yet another aspect, when seeds are directly sowed in the field, the plant-vitalizing agent is preferably used at least once for the plant bodies after 3 weeks have elapsed after germination. The frequency of use is preferably 2 to 10 times, once every one to two weeks.

### (Method for Cultivating Rice)

The cultivation form for rice is not particularly restricted, and it may be direct seeding cultivation or grafted cultivation. For cultivation of rice it is important to prepare full seedlings in order to ensure high quality rice production and high yield. In order to prepare fuller seedlings than by direct seeding with direct sowing in the field, graft cultivation is preferred in which seeding and raising of seedlings are divided, planting the raised seedlings in the field (paddy).

For graft cultivation (separate seeding and raising of seedlings), the following is one possible method as an example.

Seeds selected by salt water selection are soaked and sprouted. The seeds that have sprouted in a nursery box with laid soil are sowed and allowed to bud in a seedling grower or vinyl greenhouse. The steps from salt water selection to sprouting can be carried out by known methods. The germinated seedlings are generally raised in the open field or in a vinyl greenhouse, but a nursery with thinly spread water may also be used. Raising under conditions of 20 to 25 °C during daytime and about 10 to 15 °C at nighttime results in seedlings (also known as nursed seedlings) with a plant height of 7 to 8 cm within about one week. With a raising period of 2 to 4 weeks the seedlings reach plant heights of 10 to 13 cm (also known as grown seedlings), and reach plant heights of 13 to 18 cm by 4 to 5 weeks (also known as middle seedlings). Grown seedlings are commonly used for planting, but middle seedlings may be used in cold regions to shorten the period until earing.

The method for cultivating rice of this embodiment includes applying the plant-vitalizing agent to seedlings. As used herein, a rice “seedling” means a seedling from germination to planting when seeding and raising of seedlings are carried out separately, or when seeds are directly sowed in the field, it means the seedling from germination until the 3rd week.

According to one aspect, when seeding and raising of seedlings are carried out separately, the plant-vitalizing agent is preferably used at least once for the seedlings from 2 days to 15 days after germination, in order to obtain full seedlings. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 30 days. Planting is carried out in a water-filled paddy, using any publicly known method.

According to yet another aspect, when seeds are directly sowed in the field, the agent is preferably used at least once for seedlings from 2 days until 15 days after germination. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 18 days.

According to another aspect of the method for cultivating rice of this embodiment, the plant-vitalizing agent is preferably also applied to plant bodies after the seedling stage. As used herein, “plant body after the seedling stage”, for rice, refers to a plant body that has passed the aforementioned “seedling” stage. Specifically, it refers to the plant body after planting when seeding and raising of seedlings are carried out separately, or when seeds are directly sowed in the field, it refers to the plant body after the period from germination until the 3rd week has elapsed.

According to one aspect, when graft cultivation is carried out the plant-vitalizing agent is preferably used at least once for the plant body during 1 to 2 weeks after planting. Afterwards it is preferably used 2 to 10 times, once every one to two weeks.

According to yet another aspect, for direct seeding the plant-vitalizing agent is preferably used at least once for the plant bodies after 3 weeks have elapsed after germination. The frequency of use is preferably 2 to 10 times, once every one to two weeks.

### (Method for Cultivating Wheat)

The cultivation form for wheat is not particularly restricted, and may be either spring sowing cultivation or autumn sowing cultivation, depending on the cultivation environment.

For autumn sowing cultivation as an example, the following method may be used.

Seeding is carried out during late autumn at a mean atmospheric temperature of 12 to 16 °C, using conventional disinfection treated seeds in order to control seed infectious disease. Seeding is in a drainage-provided, plowed, soil-crushed and leveled field, generally at a raft width (row spacing) of 15 to 25 cm, a seeding width of 3 to 5 cm and a seeding amount of 6 to 8 kg/10 a. The seeding depth is about 3 cm.

In order to prevent lodging and to promote development of tillers, the growing barley is preferably compacted with a roller 2 to 3 times every 10 days to 2 weeks from the 40th to 50th day after seeding and at the beginning of the year during January to February. Fertilization management and weed control before seeding and during cultivation are preferably carried out by conventional farming methods.

Earing occurs in early April, with yellowing of the stem leaves and ear necks about 45 to 50 days after earing, whereby the cobs and grains lose their green color and enter the mature phase. Harvesting is at about 3 to 5 days later, when the grain moisture is about 30 mass % as the target.

The same applies for spring sowing cultivation as well, except for the difference in season.

The method for cultivating wheat of this embodiment includes applying the plant-vitalizing agent to seedlings. The term “seedling” as used herein in regard to wheat refers to a seedling from germination until the 3rd week.

According to one aspect, the plant-vitalizing agent is preferably used at least once for the seedlings from 2 days to 15 days after germination. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 18 days.

According to another aspect of the method for cultivating wheat of this embodiment, the plant-vitalizing agent is preferably also applied to plant bodies after the seedling stage. The term “plant body after the seedling stage” as used herein in regard to wheat refers to the plant body that has passed the “seedling” stage, i.e. a plant body after elapse of 3 weeks from germination.

According to one aspect, the plant-vitalizing agent is preferably used for the plant body at least once after the seedling stage. It is more preferably used for the plant body after the seedling stage, 2 to 10 times at a frequency of once every 10 days to 2 weeks, up to the 50th day after germination and from about February to April of the following year.

### (Method for Cultivating Corn)

The cultivation form for corn is not particularly restricted, and it may be direct seeding cultivation or grafted cultivation.

For direct seeding as an example, the following method may be used.

The seeding period is around early summer (April to May) for most regions. Base fertilizer is applied one week before seeding and the field is deeply plowed while forming ridges. For row-by-row sowing, the ridge spacing is about 60 to 100 cm and the plant spacing is about 30 cm, and holes are dug with diameters of about 7 to 10 cm and depths of about 3 to 4 cm. Three to four seeds are placed evenly in each hole, covered with dirt and lightly compacted.

When about four true leaves have appeared after germination, they are thinned out to one. Management including top dressing, soil gathering and irrigation are preferably carried out by conventional farming methods.

When silks have developed in the ears after the tassels and ears have flowered and pollinated, preferably the corn is picked leaving the uppermost ears. Harvesting begins when the silks have begun to turn brown and crimp, about 20 to 25 days after flowering.

The method for cultivating corn of this embodiment includes applying the plant-vitalizing agent to seedlings. As used herein, a corn “seedling” means a seedling from germination to planting when seeding and raising of seedlings are carried out separately, or when seeds are directly sowed in the field, it means the seedling from germination until the 3rd week.

According to one aspect, when seeding and raising of seedlings are carried out separately, the plant-vitalizing agent is preferably used at least once for the seedlings from 2 days to 15 days after germination. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 30 days.

According to yet another aspect, when seeds are directly sowed in the field, the agent is preferably used at least once for seedlings from 2 days until 15 days after germination. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 18 days.

According to another aspect of the method for cultivating corn of this embodiment, the plant-vitalizing agent is preferably also applied to plant bodies after the seedling stage. As used herein, “plant body after the seedling stage”, for corn, refers to a plant body that has passed the aforementioned “seedling” stage. Specifically, it refers to the plant body after planting when seeding and raising of seedlings are carried out separately, or when seeds are directly sowed in the field, it refers to the plant body after the period from germination until the 3rd week has elapsed.

According to one aspect, the plant-vitalizing agent is preferably used for the plant body at least once after the seedling stage. It is more preferably used for the plant body after the seedling stage, 2 to 8 times at a frequency of once every 10 days to 2 weeks, up to the 70th day after germination.

### (Method for Cultivating Sugarcane)

The cultivation form for sugarcane is not particularly restricted and may be spring planting cultivation, summer planting cultivation or stock cultivation, depending on the cultivation environment.

For spring planting cultivation as an example, the following method may be used.

It is preferred for planting to be from March to May, selecting a field in a temperate zone to subtropical or tropical zone, where the mean atmospheric temperature is 14 to 35 °C and the relative humidity is 55 to 85% during the growing period. Base fertilizer is applied one week before planting and the field is deeply plowed while forming ridges. In the case of one-ridge, two-row planting, the rows are spaced at about 30 to 50 cm and the ridges are spaced at about 120 to 160 cm. Cut stems cut to lengths of about 30 cm including the joints are planted in holes dug at plant spacings of about 100 to 150 cm and depths of about 10 to 30 cm, covered with soil, and lightly compacted. Germination occurs 2 to 3 weeks after planting, and management including top dressing, soil gathering and irrigation until harvesting is preferably carried out by conventional farming methods.

The sugarcane is reaped and harvested in December after flowering until around April of the following year. The following method is an example of post-harvest processing. The stems obtained after removing the tops, leaves and roots are juiced, hydrated lime is added and the mixture is heated to precipitate out and remove the impurities. The impurity-removed solution is boiled down and concentrated, and the resulting liquid is cooled while stirring to crystallization, to obtain brown sugar.

The same procedure applies for summer planting cultivation as well, except for the difference in season.

The same procedure is also carried out for stock cultivation, except that germination is from the post-harvested stock.

The method for cultivating sugarcane of this embodiment includes applying the plant-vitalizing agent to seedlings. The term “seedling” as used herein in regard to sugarcane refers to a seedling from germination until the 3rd week.

According to one aspect, the plant-vitalizing agent is preferably used at least once for the seedlings from 2 days to 15 days after germination. The plant-vitalizing agent is more preferably used at least once for the seedlings from 2 days to 10 days after germination, and the plant-vitalizing agent is even more preferably used at least once for the seedlings from 2 days to 5 days after germination. In order to obtain fuller seedlings, most preferably the plant-vitalizing agent is used at least once for the seedlings 2 to 15 days after germination, and at least once for the seedlings thereafter, at a frequency of once during 5 days to 18 days.

According to another aspect of the method for cultivating sugarcane of this embodiment, the plant-vitalizing agent is preferably also applied to plant bodies after the seedling stage. The term “plant body after the seedling stage” as used herein in regard to sugarcane refers to the plant body that has passed the “seedling” stage, i.e. the plant body after elapse of 3 weeks from germination.

According to one aspect, the plant-vitalizing agent is preferably used for the plant body at least once after the seedling stage. It is more preferably used for the plant body after the seedling stage, 5 to 12 times at a frequency of once every 2 to 4 weeks, up to around after the 7th month from planting.

### (Method for Cultivating Fabaceae Plants)

The cultivation form of a Fabaceae plant is not particularly restricted, and it may be outdoor cultivated, greenhouse cultivated or hydroponically cultivated. For cultivation of a Fabaceae plant it is important to prepare full seedlings in order to ensure a high quality harvest and high yield. The seeds may be directly sowed in the field, or seeding and raising of seedlings may be divided in order to prepare full seedlings, with field planting of the raised seedlings.

When seeding and raising of seedlings are divided, the following is one possible method as an example.

After placing in seeding soil in a nursery box and adequately irrigating, the seeding furrows may be cut and seeded at equal spacings. After soil covering, compaction and sufficient watering they are allowed to grow at 25 to 30 °C Soil moisture is kept in slight excess during the raising of the seedlings after germination.

The method for cultivating Fabaceae plants of this embodiment includes applying the plant-vitalizing agent to seedlings. As used herein, “seedling” means seedlings from germination until the 3rd week when seeds are directly sowed in the field, or when seeding and raising of seedlings are carried out separately it means the seedlings from germination to planting.

According to one aspect, in order to obtain full seedlings, preferably the plant-vitalizing agent is used at least once for seedlings 2 to 15 days after germination, more preferably it is used at least once for seedlings at 2 to 10 days, and even more preferably it is used at least once for seedlings at 3 to 7 days. The number of times that the plant-vitalizing agent is used during the period of 2 to 15 days after germination is preferably 1 to 2 times and more preferably once.

According to another aspect, when seeding and raising of seedlings are carried out separately, the agent is preferably used at least once for seedlings from 16 days after germination until planting. The number of times the plant-vitalizing agent is used during the period from 16 days after germination until planting will differ depending on the raising period, but it is preferably once during 5 days to 30 days, and more preferably once during 10 days to 20 days.

According to yet another aspect, when seeds are directly sowed in the field, the agent is preferably used at least once for seedlings from 16 days until 3 weeks after germination.

In order to obtain fuller seedlings, most preferably the plant-vitalizing agent is used at least once for seedlings 2 to 15 days after germination, and at least once for the seedlings thereafter, at a frequency of once during 5 days to 30 days.

According to another aspect of the method for cultivating Fabaceae plants of this embodiment, the plant-vitalizing agent is preferably also applied to plant bodies after the seedling stage. As used herein, “plant body after the seedling stage” refers to a plant body that has passed the aforementioned “seedling” stage. Specifically, it refers to the plant body after planting when seeding and raising of seedlings are carried out separately, or when seeds are directly sowed in the field, it refers to the plant body after the period from germination until the 3rd week has elapsed.

According to one aspect, when seeding and raising of seedlings are carried out separately, planting is preferably carried out with seedlings having development of 2 to 4 true leaves at about 15 to 30 days after seeding. Planting is preferably non-dense shallow planting to ensure sunlight exposure, with post-planting irrigation to promote root taking. The method of applying the plant-vitalizing agent is preferably usage at least once to the plant bodies during 1 and 2 weeks after planting. Afterwards it is preferably used 2 to 10 times, once every one to two weeks.

According to yet another aspect, when seeds are directly sowed in the field, the plant-vitalizing agent is preferably used at least once for the plant bodies after 3 weeks have elapsed after germination. The frequency of use is preferably 2 to 10 times, once every one to two weeks.

### (Application of Plant-Vitalizing Agent)

Application of the plant-vitalizing agent to at least one plant selected from the group consisting of plants of the families Solanaceae, Cucurbitaceae, Poaceae and Fabaceae may be carried out by any method commonly used by those skilled in the art without any particular restriction on the dispersion method, examples including a method of direct dispersion onto the leaves or stems of the plant, a method of dispersion into culture medium or soil in which the plant is to be cultivated, or a method of mixing into fertilizer and then dispersion into culture medium or soil. For mixing into fertilizer, the type of fertilizer is not restricted and may be chemical fertilizer comprising nitrogen, phosphoric acid and potassium, or organic fertilizer containing oil residue, fish residue, bone powder, sea weed powder, amino acids, saccharides or vitamins. The dispersion method is preferably carried out by foliar application, as this will allow the elicitor activity to be effectively exhibited. Foliar application may be carried out by a method commonly known to those skilled in the art, using a mechanical power atomizer, shoulder atomizer, broadcaster, sprayer, manned or unmanned helicopter, duster or hand sprayer.

The amount of dispersion of the plant-vitalizing agent is preferably a dispersion amount for 0.1 ng to 100 ng of active component per 1 cm² leaf surface, and more preferably a dispersion amount for 1 ng to 20 ng of active component per 1 cm² of leaf surface. Since it is difficult in practice to achieve selective dispersion on the leaf surfaces alone or adhesion of all of the dispersed solution onto the leaf surfaces on the field, the active component used at 0.01 g to 20 g per 100 m² of cultivated area is preferably diluted to a concentration of 1 ppm by mass to 100 ppm by mass in the plant-vitalizing agent, and dispersed evenly onto the plant bodies. More preferably, the active component used at 0.1 g to 10 g per 100 m² of cultivated area is diluted to a concentration of 10 ppm by mass to 500 ppm by mass in the plant-vitalizing agent.

In the method for cultivating at least one plant selected from the group consisting of plants of the families Solanaceae, Cucurbitaceae, Poaceae and Fabaceae of the embodiment, soil management is preferably carried out by a conventional farming method.

### (Effect of Plant-Vitalizing Agent)

The method for cultivating at least one plant selected from the group consisting of plants of the families Solanaceae, Cucurbitaceae, Poaceae and Fabaceae according to the embodiment comprises applying a plant-vitalizing agent comprising an exogenous elicitor and an endogenous elicitor to a seedling of at least one plant selected from the group consisting of plants of the families Solanaceae, Cucurbitaceae, Poaceae and Fabaceae. The plant-vitalizing agent comprising an exogenous elicitor and an endogenous elicitor is also preferably applied to the post-seedling stage plant body of at least one plant selected from the group consisting of plants of the families Solanaceae, Cucurbitaceae, Poaceae and Fabaceae. The reason why an effect is exhibited by applying the aforementioned plant-vitalizing agent during this period is not fully understood. It is possible that with application of an exogenous elicitor (such as one derived from a chitin oligosaccharide), disease resistance from herbivores is imparted to the plant body, but that this results in growth inhibition when in excess. When an endogenous elicitor (such as one derived from a cellooligosaccharide or xylooligosaccharide) is applied, on the other hand, this causes the plant body to recognize its own cellular damage or disrupting components (DAMPs: Damage-Associated Molecular Patterns), thereby promoting its own growth via acquired immunity and cellular repair. In the method for cultivating at least one plant selected from the group consisting of plants of the families Solanaceae, Cucurbitaceae, Poaceae and Fabaceae according to the embodiment, applying the plant-vitalizing agent comprising the exogenous elicitor and endogenous elicitor to the early-stage seedling is thought to allow growth of a tough seedling with disease resistance while reducing growth inhibition. Consecutive use of a plant-vitalizing agent on a tough raised plant body can take advantage of the growth-promoting effect of the endogenous elicitor without being significantly affected by growth inhibition by the exogenous elicitor, so that the complementary action of both agents allows a high growth-developing effect to be exhibited. It is therefore estimated that application of the plant-vitalizing agent at least once to seedlings and at least once to plant bodies after the seedling stage during cultivation of at least one plant selected from the group consisting of plants of the families Solanaceae, Cucurbitaceae, Poaceae and Fabaceae, makes it possible to achieve robust growth of the plant bodies and increased harvest yield.

The following Examples serve merely for concrete illustration of the invention and are not intended to be limitative on the invention.

### EXAMPLES

### 1. Preparation of Oligosaccharides

### (1) Chitin Oligosaccharide

A 10 g portion of chitin powder (purified chitin by Wako Pure Chemical Industries, Ltd.) was dispersed in 30 mL of water containing 1.2 g of 85% phosphoric acid (special grade reagent by Wako Pure Chemical Industries, Ltd.), the powder that had been dried under reduced pressure was placed in a 250 mL-volume alumina pot together with 100 g of alumina balls with diameters of 5 mm, and this was then set in a planetary ball mill (PULVERISETTE6 by Fritsch Co.) and treatment was carried out continuously for 6 hours at 500 rpm to obtain a reaction product. The temperature was initially room temperature, and temperature increase was allowed to proceed by shear heat release.

The reaction product was then suspended in water, and after neutralizing with calcium hydroxide, the resulting slurry solution was filtered with a Nutsche filter using 5B filter paper, and the recovered filtrate was freeze-dried to obtain the chitin oligosaccharide powder.

### (2) Cellooligosaccharide

A 271 g portion (1.8% water content, 266 g dry mass) of cotton linter pulp (cellulose content: 97%, Tokokosen Corp.) was mixed with 38 g of 85 mass % phosphoric acid (special grade reagent, product of FujiFilm-Wako Pure Chemical Industries) using a food blender (Model: HBF500S by Hamilton Beach Co.), to obtain 309 g of a reaction starting material (3.4% water content, phosphoric acid content: 10.4%).

Next, the 309 g of reaction starting material was loaded into a vibrating mill (device name: MB-1, product of Chuo Kakohki Co., Ltd., 5 L pot size), together with 13 kg of @¾-inch carbon steel balls, and subjected to hydrolysis by dry grinding for 24 hours under conditions with a total amplitude of 8 mm, a vibrational frequency of 16.2 Hz and a jacket circulation water temperature of 75 °C, after which the reaction powder was recovered.

After then placing 10 g of the reaction powder and 90 g of ion-exchanged water in a 200 L beaker, a magnetic stirrer was used for 1 hour of stirring at 25 °C to obtain a cellulose hydrolysate extract.

Next, 1.3 g of a 40 mass % aqueous calcium hydroxide solution was added to the extract, and a magnetic stirrer was used for 1 hour of stirring at 25 °C to prepare a neutral solution, collecting the supernatant using a centrifuge apparatus and freeze-drying it to obtain cellooligosaccharide powder.

### (3) Xylooligosaccharide

Acremonium cellulolyticus TN (FERM P-18508) was shake cultured for 6 days at 30 °C in a 500 mL flask containing 100 mL of liquid medium (50 g/L AVICEL, 24 g/L KH₂O₄, 5 g/L ammonium sulfate, 4.7 g/L potassium tartrate·½H₂O, 4 g/L urea, 1 g/L Tween80, 1.2 g/L MgSO₄·7H₂O, 10 mg/L ZnSO₄·7H₂O, 10 mg/L MnSO₄·5H₂O, 10 mg/L CuSO₄·5H₂O). A 5 g portion of corn cob powder was suspended in 50 mL of centrifuged supernatant of the obtained culture solution, and reacted with stirring at 50 °C for 72 hours. Centrifuged supernatant from the reaction mixture was freeze-dried to obtain xylooligosaccharide powder.

### 2. Cultivation of Solanaceae Plants

### (1) Preparation of Plant-Vitalizing Agent

Each oligosaccharide prepared in [1. Preparation of oligosaccharides] was dissolved in water while stirring with a stirrer in a compositional ratio for 1000 times the active component concentration (ppm by mass) in the plant-vitalizing agents of Examples 1A to 30A and Comparative Examples 1A to 17A listed in Table 1-1 to Table 1-4, after which the bacteria were removed with a 0.45 μm filter, to obtain plant-vitalizing agent stock solutions. Each stock solution was diluted 1000-fold with water and used for the following cultivation test. The plant-vitalizing agent obtained by 1000-fold dilution of the stock solution may also be referred to hereunder as “plant-vitalizing agent dilution”. The compositional ratios of the oligosaccharides in the tables are represented as mass %.

### (2) Cultivation Test 1A (Examples 1A to 11A and Comparative Examples 1A to 5A)

After adding commercially available seeding soil to the nursery box and thoroughly irrigating, seeding furrows were cut and tomato (Hanaotome) seeds were planted at a spacing of about 5 cm. The covered soil was lightly compacted and thoroughly watered, and left in an environment of 26 °C for germination.

The tomato field cultivation was in a vinyl greenhouse, with a total field area of 100 m², and 50 days after seeding, the tomato seedlings were planted in 20 sections with 20 seedlings per section at spacings of 50 cm, by a conventional agricultural method using chemical fertilizer.

The plant-vitalizing agent dilution was dispersed onto the germinated tomato seedlings and the plant bodies after the seedling stage, to wetting of the leaf surfaces and soil, under the conditions shown in Table 1-1.

Aqueous solutions (plant-vitalizing agent dilutions) were prepared to the active component concentrations of plant-vitalizing agent under each condition, with 1.5 kg/section each time, and from two weeks after planting, a procedure of foliar application and watering of the soil near the roots using a watering can was carried out once every 2 weeks for 2 months for a total of 5 times, after which the number of harvests per stock and the average weight and sugar content per plant for 20 seedlings (one section) were measured. The harvest weight per stock was calculated by the following formula.

(Harvest weight per stock (g/stock))=(Harvested number per stock (number/stock))×(average weight per plant (g/plant))

The weight per plant was measured by cutting out the tomato fruit alone as the edible part and measuring its weight. The sugar content was measured using a saccharimeter, after squeezing out the juice of the tomato fruit. The test results are shown in Table 1-1.

TABLE 1-1

| | | | Example | Example | Example | Example | Example | Example | Example | Example |
|---|---|---|---|---|---|---|---|---|---|---|
| | | | 1A | 2A | 3A | 4A | 5A | 6A | 7A | 8A |
| Plant | | | Tomato | Tomato | Tomato | Tomato | Tomato | Tomato | Tomato | Tomato |
| | Active component concentration in plant- | | 20 | 20 | 20 | 20 | 20 | 20 | 20 | 100 |
| | vitalizing agent (ppm by mass) | | | | | | | | | |
| Use | Seedling | Exogenous elicitor: | — | 34% | 34% | 34% | — | 25% | 25% | — |
| conditions | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | — | — | 34% | 25% | — | 25% | 34% |
| | stage (4 and | chitin oligosaccharide | | | | | | | | |
| | 6 weeks after | Endogenous elicitor: | 33% | — | — | 33% | 25% | — | 25% | 33% |
| | germination) | cellooligosaccharide | | | | | | | | |
| | | Xylooligosaccharide | 33% | — | — | 33% | 50% | — | 50% | 33% |
| | 2 months | Exogenous elicitor: | 34% | 34% | — | 34% | 25% | 25% | 25% | 34% |
| | after | chitin oligosaccharide | | | | | | | | |
| | planting | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Harvest number per stock (number/stock) | | 6.19 | 6.24 | 6.20 | 6.26 | 6.02 | 6.32 | 6.50 | 6.86 |
| | Average weight per plant (g/plant) | | 30.2 | 32.2 | 31.2 | 32.9 | 31.2 | 31.2 | 31.3 | 29.8 |
| | Harvest weight per stock (g/stock) | | 186.94 | 200.93 | 193.44 | 205.95 | 187.82 | 197.18 | 203.45 | 204.43 |
| | Average sugar content per plant (%) | | 7.83 | 7.88 | 8.01 | 7.89 | 8.00 | 7.98 | 7 98 | 7 92 |
| | | | | | | Comp. | Comp. | Comp. | Comp. | Comp. |
| | | | Example | Example | Example | Example | Example | Example | Example | Example |
| | | | 9A | 10A | 11A | 1A | 2A | 3A | 4 A | 5A |
| Plant | | | Tomato | Tomato | Tomato | Tomato | Tomato | Tomato | Tomato | Tomato |
| Use | Active component concentration in plant- | | 100 | 100 | 100 | 0 | 20 | 20 | 20 | 20 |
| conditions | vitalizing agent (ppm by mass) | | | | | | | | | |
| | Seedling | Exogenous elicitor: | 34% | — | 25% | — | — | — | 100% | — |
| | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | — | 50% | — | — | — | — | 66% |
| | Seedling | Exogenous elicitor: | 34% | 25% | 25% | — | — | 100% | 100% | — |
| | stage (4 and | chitin oligosaccharide | | | | | | | | |
| | 6 weeks after | Endogenous elicitor: | 33% | 25% | 25% | — | — | — | — | 34% |
| | germination) | cellooligosaccharide | | | | | | | | |
| | | Xylooligosaccharide | 33% | 50% | 50% | — | — | — | — | 66% |
| | 2 months | Exogenous elicitor: | 34% | 25% | 25% | — | 34% | 100% | 100% | — |
| | after | chitin oligosaccharide | | | | | | | | |
| | planting | Endogenous elicitor: | 33% | 25% | 25% | — | 33% | — | — | 34% |
| | (once/ | cellooligosaccharide | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Harvest number per stock (number/stock) | 7.13 | 6.94 | 7.09 | 5.15 | 5.25 | 6.92 | 7.06 | 6.57 |
| | Average weight per plant (g/plant) | 32.1 | 29.1 | 32.3 | 24.1 | 28.4 | 23 JJ | 23.7 | 26.0 |
| | Harvest weight per stock (g/stock) | 228.87 | 201.85 | 229.01 | 123.91 | 149.10 | 164.7 | 167.32 | 170.82 |
| | Average sugar content per plant (%) | 7.88 | 8.01 | 8.03 | 7.43 | 8.05 | 7.55 | 7.52 | 7.99 |

### (3) Cultivation Test 2A (Grafted Seedlings) (Examples 12A to 15A and Comparative Examples 6A to 11A)

After adding commercially available seeding soil to the nursery box and thoroughly irrigating, seeding furrows were cut and rootstock tomato (Tm-2a-type combined resistance) seeds were planted at a spacing of about 5 cm. The covered soil was lightly compacted and thoroughly watered, and left in an environment of 26 °C for germination. Scion tomatoes (Hanaotome) were also seeded and germinated in the same manner as cultivation test 1A, at 2 days after seeding of the rootstock tomatoes. At 18 days after scion seeding, grafting was carried out by a publicly known method using the rootstocks and scions with 3 to 4 developed true leaves, and they were allowed to take root to grow grafted seedlings. At 20 days after grafting, the grafted seedlings were planted in a field.

The plant-vitalizing agent dilution was dispersed onto the germinated tomato seedlings (scions) and the plant bodies after the seedling stage, to wetting of the leaf surfaces and soil, under the conditions shown in Table 1-2.

Field cultivation was carried out according to cultivation test 1A, and the harvest number per stock for 20 seedlings and the average weight per plant were measured. The harvest weight per stock was also calculated in the same manner as cultivation test 1A. The test results are shown in Table 1-2.

TABLE 1-2

| | | | | | | | Comp. | Comp. | Comp. | Comp. | Comp. | Comp. |
|---|---|---|---|---|---|---|---|---|---|---|---|---|
| | | | Ex- | Ex- | Ex- | Ex- | Ex- | Ex- | Ex- | Ex- | Ex- | Ex- |
| | | | ample | ample | ample | ample | ample | ample | ample | ample | ample | ample |
| | | | 12A | 13A | 14A | 15A | 6A | 7A | 8A | 9A | 10A | 11A |
| Plant | | | Tomato | Tomato | Tomato | Tomato | Tomato | Tomato | Tomato | Tomato | Tomato | Tomato |
| | Active component concentration in plant- | | 100 | 100 | 100 | 100 | 100 | 100 | 0 | 100 | 100 | 100 |
| | vitalizing agent (ppm by mass) | | | | | | | | | | | |
| Use | Seedling | Exogenous elicitor: | 34% | 34% | 25% | 25% | — | — | — | — | — | 100% |
| conditions | stage | chitin oligosaccharide | | | | | | | | | | |
| | (scion) (4 | Endogenous elicitor: | 33% | 33% | 25% | 25% | — | — | — | — | — | — |
| | days after | cellooligosaccharide | | | | | | | | | | |
| | germination) | Xylooligosaccharide | 33% | 33% | 50% | 50% | — | — | — | — | — | — |
| | Rootstock (4 | Exogenous elicitor: | — | 34% | — | 25% | — | — | — | — | — | 100% |
| | days after | chitin oligosaccharide | | | | | | | | | | |
| | germination) | Endogenous elicitor: | — | 33% | — | 25% | — | — | — | — | — | — |
| | | cellooligosaccharide | | | | | | | | | | |
| | | Xylooligosaccharide | — | 33% | — | 50% | — | — | — | — | — | — |
| | Grafted | Exogenous elicitor: | 34% | 34% | 25% | 25% | 34% | 25% | — | — | 100% | 100% |
| | seedling (10 | chitin oligosaccharide | | | | | | | | | | |
| | days after | Endogenous elicitor: | 33% | 33% | 25% | 25% | 33% | 25% | — | — | — | — |
| | grafting) | cellooligosaccharide | | | | | | | | | | |
| | | Xylooligosaccharide | 33% | 33% | 50% | 50% | 33% | 50% | — | — | — | — |
| | 2 months | Exogenous elicitor: | 34% | 34% | 25% | 25% | 34% | 25% | — | 34% | 100% | 100% |
| | after | chitin oligosaccharide | | | | | | | | | | |
| | planting | Endogenous elicitor: | 33% | 33% | 25% | 25% | 33% | 25% | — | 33% | — | — |
| | (once/ | cellooligosaccharide | | | | | | | | | | |
| | 2 weeks) | Xylooligosaccharide | 33% | 33% | 50% | 50% | 33% | 50% | — | 33% | — | — |

| | | | | | | | | | | | |
|---|---|---|---|---|---|---|---|---|---|---|---|
| Results | Harvest number per stock (number/stock) | 7.12 | 7.14 | 7.16 | 7.22 | 6.86 | 6.95 | 5.40 | 5.82 | 6.80 | 6.76 |
| | Average weight per plant (g/plant) | 32.3 | 32.2 | 32.5 | 33.0 | 30.0 | 30.3 | 25.2 | 28.2 | 24.5 | 24.8 |
| | Harvest weight per stock (g/stock) | 230.0 | 234.9 | 232.7 | 238.3 | 206.4 | 210.6 | 136.1 | 164.1 | 166.6 | 167.6 |

### (4) Cultivation Test 3A (Examples 16A to 26A and Comparative Examples 12A to 16A)

The test was conducted using potato as a Solanaceae plant.

An open field was plowed to a depth of 25 to 30 cm, and seed potatoes (May Queen) were planted in holes dug at a plant spacing of 30 cm and 10 cm depth in high ridges with ridge widths of 50 cm, and were germinated and sprouted by a conventional farming method. The potato seedlings were divided into 5 per section and grown by a conventional farming method using chemical fertilizer.

The plant-vitalizing agent dilution was dispersed onto the germinated potato seedlings and the plant bodies after the seedling stage, to wetting of the leaf surfaces and soil, under the conditions shown in Table 1-3.

Aqueous solutions (plant-vitalizing agent dilutions) were prepared to the active component concentrations of plant-vitalizing agent under each condition, with 0.2 kg/section each time, and from three weeks after germination, a procedure of foliar application and watering of the soil near the roots using a watering can was carried out once every 2 weeks for 2 months for a total of 5 times, after which the standard average harvested number per stock and the standard average harvested gross weight per stock for 25 seedlings (5 sections) were measured. For this experiment, “standard” is ≥30 g of potato.

The average harvest gross weight per stock was measured by measuring the standard gross weight among the harvested potato. The degradation rate (%) was calculated as: (harvest number of non-standard potato (<30 g)/total harvest number)×100. The test results are shown in Table 1-3.

TABLE 1-3

| | | | Ex- | Ex- | Ex- | Ex- | Ex- | Ex- | Ex- | Ex- |
|---|---|---|---|---|---|---|---|---|---|---|
| | | | ample | ample | ample | ample | ample | ample | ample | ample |
| | | | 16A | 17A | 18A | 19A | 20A | 21A | 22 A | 23A |
| Plant | | | Potato | Potato | Potato | Potato | Potato | Potato | Potato | Potato |
| Use | Active component concentration in plant- | | 20 | 20 | 20 | 20 | 20 | 20 | 20 | 100 |
| conditions | vitalizing agent (ppm by mass) | | | | | | | | | |
| | Seedling | Exogenous elicitor: | — | 34% | 34% | 34% | — | 25% | 25% | — |
| | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | — | — | 34% | 25% | | 25% | 34% |
| | stage (14 | chitin oligosaccharide | | | | | | | | |
| | days after | Endogenous elicitor: | 33% | — | — | 33% | 25% | | 25% | 33% |
| | germination) | cellooligosaccharide | | | | | | | | |
| | | Xylooligosaccharide | 33% | — | — | 33% | 50% | | 50% | 33% |
| | 3 weeks to 2 | Exogenous elicitor: | 34% | 34% | — | 34% | 25% | 25% | 25% | 34% |
| | months after | chitin oligosaccharide | | | | | | | | |
| | germination | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Average number standard potatoes per stock (number/stock) | | 9.2 | 9.6 | 9.5 | 9.4 | 9.1 | 9.6 | 9.6 | 9.9 |
| | Average gross weight standard potatoes per stock (g/stock) | | 934 | 950 | 942 | 965 | 951 | 950 | 976 | 948 |
| | Degradation rate (%) | | 9.9 | 9.3 | 9.6 | 8.1 | 9.4 | 8.9 | 7.9 | 8.9 |
| | | | | | | Comp. | Comp. | Comp. | Comp. | Comp. |
| | | | Ex- | Ex- | Ex- | Ex- | Ex- | Ex- | Ex- | Ex- |
| | | | ample | ample | ample | ample | ample | ample | ample | ample |
| | | | 24A | 25A | 26 A | 12A | 13A | 14A | 15A | 16A |
| Plant | | | Potato | Potato | Potato | Potato | Potato | Potato | Potato | Potato |
| Use | Active component concentration in plant- | | 100 | 100 | 100 | 0 | 20 | 20 | 20 | 20 |
| conditions | vitalizing agent (ppm by mass) | | | | | | | | | |
| | Seedling | Exogenous elicitor: | 34% | — | 25% | — | — | — | 100% | — |
| | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | — | 50% | — | — | — | — | 66% |
| | Seedling | Exogenous elicitor: | 34% | 25% | 25% | — | — | 100% | 100% | — |
| | stage (14 | chitin oligosaccharide | | | | | | | | |
| | days after | Endogenous elicitor: | 33% | 25% | 25% | — | — | — | — | 34% |
| | germination) | cellooligosaccharide | | | | | | | | |
| | | Xylooligosaccharide | 33% | 50% | 50% | — | — | — | — | 66% |
| | 3 weeks to 2 | Exogenous elicitor: | 34% | 25% | 25% | — | 34% | 100% | 100% | — |
| | months after | chitin oligosaccharide | | | | | | | | |
| | germination | Endogenous elicitor: | 33% | 25% | 25% | — | 33% | — | — | 34% |
| | (once/ | cellooligosaccharide | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Average number standard potatoes per stock (number/stock) | 10.6 | 10.1 | 10.2 | 7.6 | 7.8 | 8.2 | 8.6 | 8.4 |
| | Average gross weight standard potatoes per stock (g/stock) | 982 | 955 | 996 | 864 | 871 | 878 | 882 | 890 |
| | Degradation rate (%) | 8.1 | 7.5 | 6.8 | 16.2 | 13 | 12.8 | 12.8 | 12.2 |

### (5) Cultivation Test 4A (Examples 27A to 30A and Comparative Example 17A)

A test was conducted in the same manner as cultivation test 1A, using bell pepper as a Solanaceae plant. Bell pepper was harvested when the fruit length was 5 to 7 cm, and final comparison was made based on the harvest number per stock. The test results are shown in Table 1-4.

TABLE 1-4

| | | | | | | | Comp. |
|---|---|---|---|---|---|---|---|
| | | | Example | Example | Example | Example | Example |
| | | | 27A | 28 A | 29 A | 30A | 17A |
| Plant | | | Bell pepper | Bell pepper | Bell pepper | Bell pepper | Bell pepper |
| Use | Active component concentration in plant- | | 20 | 20 | 100 | 100 | 0 |
| conditions | vitalizing agent (ppm by mass) | | | | | | |
| | Seedling | Exogenous elicitor: | | 25% | | 25% | — |
| | stage (4 | chitin oligosaccharide | | | | | |
| | days after | Endogenous elicitor: | | 25% | | 25% | — |
| | germination) | cellooligosaccharide | | | | | |
| | | Xylooligosaccharide | | 50% | | 50% | |
| | Seedling | Exogenous elicitor: | 25% | 25% | 25% | 25% | — |
| | stage (4 | chitin oligosaccharide | | | | | |
| | weeks after | Endogenous elicitor: | 25% | 25% | 25% | 25% | — |
| | germination) | cellooligosaccharide | | | | | |
| | | Xylooligosaccharide | 50% | 50% | 50% | 50% | |
| | 2 months | Exogenous elicitor: | 25% | 25% | 25% | 25% | — |
| | after planting | chitin oligosaccharide | | | | | |
| | (once/2 | Endogenous elicitor: | 25% | 25% | 25% | 25% | — |
| | weeks) | cellooligosaccharide | | | | | |
| | | Xylooligosaccharide | 50% | 50% | 50% | 50% | |

| | | | | | |
|---|---|---|---|---|---|
| Harvest number per stock (number/stock) | 144 | 153 | 161 | 168 | 127 |

The results in Table 1-1 and Table 1-2 confirmed that harvest yield can be markedly increased during cultivation of tomato as a Solanaceae plant, if a plant-vitalizing agent including both an exogenous elicitor and an endogenous elicitor is used for seedlings. In Examples 1A to 11A, not only were the harvest yields high, but tomatoes with high sugar content were obtained. In addition, the results in Table 1-3 confirmed that harvest yield can be markedly increased during cultivation of potato as a Solanaceae plant, if a plant-vitalizing agent including both an exogenous elicitor and an endogenous elicitor is used for seedlings. The results in Table 1-4 confirmed that harvest number can be markedly increased during cultivation of bell pepper as a Solanaceae plant, if a plant-vitalizing agent including both an exogenous elicitor and an endogenous elicitor is used for seedlings.

### 3. Cultivation of Cucurbitaceae Plants

### (1) Preparation of Plant-Vitalizing Agent

Each oligosaccharide prepared in [1. Preparation of oligosaccharides] was dissolved in water while stirring with a stirrer in a compositional ratio for 1000 times the active component concentration (ppm by mass) in the plant-vitalizing agents of Examples 1B to 19B and Comparative Examples 1B to 12B listed in Table 2-1 to Table 2-3, after which the bacteria were removed with a 0.45 μm filter, to obtain plant-vitalizing agent stock solutions. Each stock solution was diluted 1000-fold with water and used for the following cultivation test. The plant-vitalizing agent obtained by 1000-fold dilution of the stock solution may also be referred to as “plant-vitalizing agent dilution”. The compositional ratios of the oligosaccharides in the tables are represented as mass %.

### (2) Cultivation Test 1B (Examples 1B to 11B and Comparative Examples 1B to 5B)

After adding commercially available seeding soil to the nursery box and thoroughly irrigating, seeding furrows were cut and watermelon (Shimaou) seeds were planted at a spacing of about 1 cm. The covered soil was lightly compacted and thoroughly watered, and left in an environment of 28 °C for germination.

The watermelon field cultivation was in a vinyl greenhouse, with a total field area of 300 m², and 40 days after seeding, the watermelon seedlings were planted in 18 sections with 10 seedlings per section, with ridge widths of 160 cm and spacings of 90 cm, by a conventional agricultural method using chemical fertilizer.

The plant-vitalizing agent dilution was dispersed onto the germinated watermelon seedlings and the plant bodies after the seedling stage, to wetting of the leaf surfaces and soil, under the conditions shown in Table 2-1.

Aqueous solutions (plant-vitalizing agent dilutions) were prepared to the active component concentrations of plant-vitalizing agent under each condition, with 2.0 kg/section each time, and from two weeks after planting, a procedure of foliar application and watering of the soil near the roots using a watering can was carried out once every 2 weeks for 2 months for a total of 5 times. Cultivation was carried out taking one fruit leaving 3 vines per stock, and the average harvest yield and average sugar content per stock of fruit for 10 seedlings (1 group) were measured 40 days after flowering and cross-breeding, with comparison being made between the different conditions.

The harvest yield was measured by measuring the weight of the cut watermelon fruit. The sugar content was measured using a saccharimeter, after squeezing out the juice of the watermelon fruit. The test results are shown in Table 2-1.

TABLE 2-1

| | | | Example | Example | Example | Example | Example | Example | Example | Example |
|---|---|---|---|---|---|---|---|---|---|---|
| | | | 1B | 2B | 3B | 4B | 5B | 6B | 7B | 8B |
| Plant | | | Water- | Water- | Water- | Water- | Water- | Water- | Water- | Water- |
| | | | melon | melon | melon | melon | melon | melon | melon | melon |
| | Active component concentration in plant- | | 20 | 20 | 20 | 20 | 20 | 20 | 20 | 20 |
| | vitalizing agent (ppm by mass) | | | | | | | | | |
| Use | Seedling | Exogenous elicitor: | — | 34% | 34% | 34% | — | 25% | 25% | — |
| conditions | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | | — | 34% | 25% | — | 25% | 34% |
| | stage (4 | chitin oligosaccharide | | | | | | | | |
| | weeks after | cellooligosaccharide | 33% | — | — | 33% | 25% | — | 25% | 33% |
| | germination) | Endogenous elicitor: | | | | | | | | |
| | | Xylooligosaccharide | 33% | — | — | 33% | 50% | — | 50% | 33% |
| | 2 months | Exogenous elicitor: | 34% | 34% | — | 34% | 25% | 25% | 25% | 34% |
| | after | chitin oligosaccharide | | | | | | | | |
| | planting | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Harvest yield (kg/stock) | | 14.6 | 15.1 | 14.8 | 15.8 | 15.2 | 15.9 | 16.6 | 15.1 |
| | Average sugar content (%) | | 11.4 | 11.5 | 11.3 | 11.6 | 11.5 | 11.5 | 11.9 | 11.4 |
| | | | | | | Comp. | Comp. | Comp. | Comp. | Comp. |
| | | | Example | Example | Example | Example | Example | Example | Example | Example |
| | | | 9B | 10B | 11B | 1B | 2B | 3B | 4B | 5B |
| Plant | | | Water- | Water- | Water- | Water- | Water- | Water- | Water- | Water- |
| | | | melon | melon | melon | melon | melon | melon | melon | melon |
| | Active component concentration in plant- | | 20 | 20 | 20 | 0 | 20 | 20 | 20 | 20 |
| | vitalizing agent (ppm by mass) | | | | | | | | | |
| Use | Seedling | Exogenous elicitor: | 34% | — | 25% | — | — | — | 100% | — |
| conditions | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | — | 50% | — | — | — | — | 65% |
| | Seedling | Exogenous elicitor: | 34% | 25% | 25% | — | — | 100% | 100% | — |
| | stage (4 | chitin oligosaccharide | | | | | | | | |
| | weeks after | cellooligosaccharide | 33% | 25% | 25% | — | — | — | — | 34% |
| | germination) | Endogenous elicitor: | | | | | | | | |
| | | Xylooligosaccharide | 33% | 50% | 50% | — | — | — | — | 66% |
| | 2 months | Exogenous elicitor: | 34% | 25% | 25% | — | 34% | 100% | 100% | — |
| | after | chitin oligosaccharide | | | | | | | | |
| | planting | Endogenous elicitor: | 33% | 25% | 25% | — | 33% | — | — | 34% |
| | (once/ | cellooligosaccharide | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Harvest yield (kg/stock) | 16.8 | 16.4 | 17.2 | 11.9 | 13.6 | 13.1 | 13.8 | 14.0 |
| | Average sugar content (%) | 11.8 | 11.7 | 12.1 | 10.8 | 11.1 | 10.7 | 10.6 | 11.2 |

### (3) Cultivation Test 2B (Grafted Seedlings) (Examples 12B to 15B and Comparative Examples 6B to 11B)

After adding commercially available seeding soil to the nursery box and thoroughly irrigating, seeding furrows were cut and watermelon rootstock Kanpyou (FR Kizuna) seeds were planted at a spacing of about 1 cm. The covered soil was lightly compacted and thoroughly watered, and left in an environment of 28 °C for germination. At 1 week after seeding watermelon rootstock Kanpyou seeds, seeding and germination of scion watermelon (Shimaou) was carried out, in the same manner as cultivation test 1B. At 1 week after scion seeding, grafting was carried out by a publicly known method using rootstocks with 1 or 2 developed true leaves and scions with developed cotyledons, and they were allowed to take root to grow grafted seedlings. At 20 days after grafting, the grafted seedlings were planted in a field.

The plant-vitalizing agent dilution was dispersed onto the germinated watermelon seedlings (scions) and the plant bodies after the seedling stage according to cultivation test 1B, under the conditions shown in Table 2-2.

Field cultivation was carried out according to cultivation test 1B, and the average harvest yield and average sugar content for 10 seedlings were measured. The test results are shown in Table 2-2.

TABLE 2-2

| | | | | | | | Comp. | Comp. | Comp. | Comp. | Comp. | Comp. |
|---|---|---|---|---|---|---|---|---|---|---|---|---|
| | | | Ex- | Ex- | Ex- | Ex- | Ex- | Ex- | Ex- | Ex- | Ex- | Ex- |
| | | | ample | ample | ample | ample | ample | ample | ample | ample | ample | ample |
| | | | 12B | 13B | 14B | 15B | 6B | 7B | 8B | 9B | 10 B | 11B |
| Plant | | | Water- | Water- | Water- | Water- | Water- | Water- | Water- | Water- | Water- | Water- |
| | | | melon | melon | melon | melon | melon | melon | melon | melon | melon | melon |
| Use | Active component concentration in plant- | | 100 | 100 | 100 | 100 | 100 | 100 | 0 | 100 | 100 | 100 |
| conditions | vitalizing agent (ppm by mass) | | | | | | | | | | | |
| | Seedling | Exogenous elicitor: | 34% | 34% | 25% | 25% | — | — | — | — | — | 100% |
| | stage | chitin oligosaccharide | | | | | | | | | | |
| | (scion) (4 | Endogenous elicitor: | 33% | 33% | 25% | 25% | — | — | — | — | — | — |
| | days after | cellooligosaccharide | | | | | | | | | | |
| | germination) | Xylooligosaccharide | 33% | 33% | 50% | 50% | — | — | — | — | — | — |
| | Rootstock (4 | Exogenous elicitor: | — | 34% | — | 25% | — | — | — | — | — | 100% |
| | days after | chitin oligosaccharide | | | | | | | | | | |
| | germination) | Endogenous elicitor: | — | 33% | — | 25% | — | — | — | — | — | — |
| | | cellooligosaccharide | | | | | | | | | | |
| | | Xylooligosaccharide | — | 33% | — | 50% | — | — | — | — | — | — |
| | Grafted | Exogenous elicitor: | 34% | 34% | 25% | 25% | 34% | 25% | — | — | 100% | 100% |
| | seedling (10 | chitin oligosaccharide | | | | | | | | | | |
| | days after | Endogenous elicitor: | 33% | 33% | 25% | 25% | 33% | 25% | — | — | — | — |
| | grafting) | cellooligosaccharide | | | | | | | | | | |
| | | Xylooligosaccharide | 33% | 33% | 50% | 50% | 33% | 50% | — | — | — | — |
| | 2 months | Exogenous elicitor: | 34% | 34% | 25% | 25% | 34% | 25% | — | 34% | 100% | 100% |
| | after | chitin oligosaccharide | | | | | | | | | | |
| | planting | Endogenous elicitor: | 33% | 33% | 25% | 25% | 33% | 25% | — | 33% | — | — |
| | (once/ | cellooligosaccharide | | | | | | | | | | |
| | 2 weeks) | Xylooligosaccharide | 33% | 33% | 50% | 50% | 33% | 50% | — | 33% | — | — |

| | | | | | | | | | | | |
|---|---|---|---|---|---|---|---|---|---|---|---|
| Results | Harvest yield (kg/stock) | 16.2 | 16.4 | 16.8 | 17.4 | 15.2 | 15.8 | 12.4 | 14.2 | 14.4 | 14.6 |
| | Average sugar content (%) | 11.6 | 11.6 | 11.6 | 11.8 | 11.5 | 11.3 | 10.8 | 11.0 | 10.9 | 10.9 |

### (4) Cultivation Test 3B (Examples 16B to 19B and Comparative Example 12B)

A test was carried out using cucumber (Natsusuzumi) as a Cucurbitaceae plant, in the same manner as cultivation test 1B.

The germinated cucumber seedlings were appropriately thinned and raised for 30 days, and seedlings that developed 3 to 4 true leaves were planted in a field. The plant-vitalizing agent dilution was dispersed onto the seedlings and the plant bodies after the seedling stage according to cultivation test 1B, under the conditions shown in Table 2-3.

Cucumber was successively harvested when the fruit length was about 20 cm, and final comparison was made based on the total harvest number per stock. The test results are shown in Table 2-3.

TABLE 2-3

| | | | | | | | Comp. |
|---|---|---|---|---|---|---|---|
| | | | Example | Example | Example | Example | Example |
| | | | 16B | 17B | 18B | 19 B | 12B |
| Plant | | | Cucumber | Cucumber | Cucumber | Cucumber | Cucumber |
| Use | Active component concentration in plant- | | 20 | 20 | 100 | 100 | 0 |
| conditions | vitalizing agent (ppm by mass) | | | | | | |
| | Seedling | Exogenous elicitor: | — | 25% | — | 25% | — |
| | stage (4 | chitin oligosaccharide | | | | | |
| | days after | Endogenous elicitor: | — | 25% | — | 25% | — |
| | germination) | cellooligosaccharide | | | | | |
| | | Xylooligosaccharide | — | 50% | — | 50% | — |
| | Seedling | Exogenous elicitor: | 25% | 25% | 25% | 25% | — |
| | stage (4 | chitin oligosaccharide | | | | | |
| | weeks after | Endogenous elicitor: | 25% | 25% | 25% | 25% | — |
| | germination) | cellooligosaccharide | | | | | |
| | | Xylooligosaccharide | 50% | 50% | 50% | 50% | — |
| | 2 months | Exogenous elicitor: | 25% | 25% | 25% | 25% | — |
| | after | chitin oligosaccharide | | | | | |
| | planting | Endogenous elicitor: | 25% | 25% | 25% | 25% | — |
| | (once/ | cellooligosaccharide | | | | | |
| | 2 weeks) | Xylooligosaccharide | 50% | 50% | 50% | 50% | — |

| | | | | | |
|---|---|---|---|---|---|
| Average harvest number per stock (number/stock) | 34 | 42 | 38 | 46 | 28 |

The results in Table 2-1 and Table 2-2 confirmed that harvest yield can be markedly increased during cultivation of watermelon as a Cucurbitaceae plant, if a plant-vitalizing agent including both an exogenous elicitor and an endogenous elicitor is used for seedlings. In Examples 1B to 15B, not only were the harvest yields high, but watermelons with high sugar content were obtained. The results in Table 2-3 also confirmed that harvest number can be markedly increased during cultivation of cucumber as a Cucurbitaceae plant, if a plant-vitalizing agent including both an exogenous elicitor and an endogenous elicitor is used for seedlings.

### 4. Cultivation of Poaceae Plants

### (1) Preparation of Plant-Vitalizing Agent

Each oligosaccharide prepared in [1. Preparation of oligosaccharides] was dissolved in water while stirring with a stirrer in a compositional ratio for 1000 times the active component concentration (ppm by mass) in the plant-vitalizing agents of Examples 1C to 28C and Comparative Examples 1C to 14C listed in Table 3-1 to Table 3-3, after which the bacteria were removed with a 0.45 μm filter, to obtain plant-vitalizing agent stock solutions. Each stock solution was diluted 1000-fold with water and used for the following cultivation test. The plant-vitalizing agent obtained by 1000-fold dilution of the stock solution may also be referred to hereunder as “plant-vitalizing agent dilution”. The compositional ratios of the oligosaccharides in the tables are represented as mass %.

### (2) Cultivation Test 1C (Rice Cultivation) (Examples 1C to 11C and Comparative Examples 1C to 5C)

Commercial seeding soil was placed in a nursery box (580×280 mm) and thoroughly irrigated, and seeds of rice (Akita Komachi) sprouted by a publicly known method were seeded at 170 g/box. Germination was after soil covering and standing for 2 days in an environment of 30 °C.

The rice was planted using grown seedlings raised to about 12 cm by 3 weeks after germination. A puddled 100 m² paddy was divided into 20 squares, with a seedling count of 3 per stock and a planting density of 100 stocks/square (20 stocks/m²), by a conventional agricultural method using chemical fertilizer.

The plant-vitalizing agent dilution was dispersed onto the germinated rice seedlings and the planted plant bodies after the seedling stage, to wetting of the leaf surfaces and soil, under the conditions shown in Table 3-1.

Aqueous solutions (plant-vitalizing agent dilutions) were prepared to the active component concentrations of plant-vitalizing agent under each condition, with 1 kg/section each time, and from two weeks after planting, a procedure of foliar application using a watering can was carried out once every 2 weeks for 2 months for a total of 5 times, after which harvesting was carried out by a conventional farming method and the harvest yield per section (100 stocks) (hull weight) was measured. The test results are shown in Table 3-1.

TABLE 3-1

| | | | Example | Example | Example | Example | Example | Example | Example | Example |
|---|---|---|---|---|---|---|---|---|---|---|
| | | | 1C | 2C | 3C | 4 C | 5C | 6C | 7C | 8C |
| Plant | | | Rice | Rice | Rice | Rice | Rice | Rice | Rice | Rice |
| | Active component concentration in plant- | | 20 | 20 | 20 | 20 | 20 | 20 | 20 | 100 |
| | vitalizing agent (ppm by mass) | | | | | | | | | |
| Use | Seedling | Exogenous elicitor: | — | 34% | 34% | 34% | — | 25% | 25% | — |
| conditions | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | — | — | 34% | 25% | — | 25% | 34% |
| | stage (16 | chitin oligosaccharide | | | | | | | | |
| | days after | Endogenous elicitor: | 33% | — | — | 33% | 25% | — | 25% | 33% |
| | germination) | cellooligosaccharide | | | | | | | | |
| | | Xylooligosaccharide | 33% | — | — | 33% | 50% | — | 50% | 33% |
| | 2 months | Exogenous elicitor: | 34% | 34% | — | 34% | 25% | 25% | 25% | 34% |
| | after | chitin oligosaccharide | | | | | | | | |
| | planting | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Harvest yield per section (hull weight, kg) | | 2.92 | 3.08 | 3.00 | 3.10 | 2.98 | 3.12 | 3.16 | 2.99 |
| | | | | | | Comp. | Comp. | Comp. | Comp. | Comp. |
| | | | Example | Example | Example | Example | Example | Example | Example | Example |
| | | | 9C | 10C | 11C | 1C | 2C | 3C | 4C | 5C |
| Plant | | | Rice | Rice | Rice | Rice | Rice | Rice | Rice | Rice |
| | Active component concentration in plant- | | 100 | 100 | 100 | 0 | 20 | 20 | 20 | 20 |
| | vitalizing agent (ppm by mass) | | | | | | | | | |
| Use | Seedling | Exogenous elicitor: | 34% | — | 25% | — | — | — | 100% | — |
| conditions | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | — | 50% | — | — | — | — | 66% |
| | Seedling | Exogenous elicitor: | 34% | 25% | 25% | — | — | 100% | 100% | — |
| | stage (16 | chitin oligosaccharide | | | | | | | | |
| | days after | Endogenous elicitor: | 33% | 25% | 25% | — | — | — | — | 34% |
| | germination) | cellooligosaccharide | | | | | | | | |
| | | Xylooligosaccharide | 33% | 50% | 50% | — | — | — | — | 66% |
| | 2 months | Exogenous elicitor: | 34% | 25% | 25% | — | 34% | 100% | 100% | — |
| | after | chitin oligosaccharide | | | | | | | | |
| | planting | cellooligosaccharide | 33% | 25% | 25% | — | 33% | — | — | 34% |
| | (once/ | Endogenous elicitor: | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Harvest yield per section (hull weight, kg) | 3.18 | 3.01 | 3.22 | 2.59 | 2.62 | 2.66 | 2.68 | 2.72 |

### (3) Cultivation Test 2C (Autumn Sowing Cultivation of Wheat) (Examples 12C to 17C and Comparative Examples 6C to 9C)

In late November when the mean atmospheric temperature reached 13 to 15 °C, disinfected seeds (IwainoDaichi) were seeded by a publicly known method into a field that had been fertilized, plowed, soil-crushed and leveled by conventional farming methods. A 100 m² field divided into 20 sections was used for the test. The seeding method was with 0.7 kg of seeds over the entire 100 m² field, with a row spacing of 20 cm, a seeding width of 4 cm and a depth of about 3 cm. On the 45th day after seeding when 3 or 4 true leaves appeared and in early and late February, the soil was compacted a total of 3 times using a roller. Other management including fertilization, weeding and irrigation were carried out by conventional farming methods.

The plant-vitalizing agent dilution was dispersed over the leaf surfaces of the germinated wheat seedlings and the plant bodies after the seedling stage, under the conditions shown in Table 3-2.

Aqueous solutions (plant-vitalizing agent dilutions) were prepared to the active component concentrations of plant-vitalizing agent under each condition, with 1.5 kg/section each time, and a procedure of foliar application using a watering can was carried out as shown in Table 3-2, followed by harvesting on the 50th day after earing, and the harvest yield per section (hull weight) was measured. The test results are shown in Table 3-2.

TABLE 3-2

| | | | Example | Example | Example | Example | Example |
|---|---|---|---|---|---|---|---|
| | | | 12C | 13C | 14C | 15C | 16C |
| Plant | | | Wheat | Wheat | Wheat | Wheat | Wheat |
| | Active component concentration in plant- | | 100 | 100 | 100 | 100 | 100 |
| | vitalizing agent (ppm by mass) | | | | | | |
| Use | Seedling | Exogenous elicitor: | — | 34% | 34% | — | 25% |
| conditions | stage (4 | chitin oligosaccharide | | | | | |
| | days after | Endogenous elicitor: | — | 33% | 33% | — | 25% |
| | germination) | cellooligosaccharide | | | | | |
| | | Xylooligosaccharide | — | 33% | 33% | — | 50% |
| | Seedling | Exogenous elicitor: | 34% | — | 34% | 25% | — |
| | stage (18 | chitin oligosaccharide | | | | | |
| | days after | Endogenous elicitor: | 33% | — | 33% | 25% | — |
| | germination) | cellooligosaccharide | | | | | |
| | | Xylooligosaccharide | 33% | — | 33% | 50% | — |
| | March-April | Exogenous elicitor: | 34% | 34% | 34% | 25% | 25% |
| | following | chitin oligosaccharide | | | | | |
| | year | Endogenous elicitor: | 33% | 33% | 33% | 25% | 25% |
| | (once/ | cellooligosaccharide | | | | | |
| | 2 weeks) | Xylooligosaccharide | 33% | 33% | 33% | 50% | 50% |
| Results | Harvest yield per section (hull weight, kg) | | 2.44 | 2.52 | 2.58 | 2.48 | 2.56 |
| | | | | Comp. | Comp. | Comp. | Comp. |
| | | | Example | Example | Example | Example | Example |
| | | | 17C | 6C | 7 C | 8C | 9 C |
| Plant | | | Wheat | Wheat | Wheat | Wheat | Wheat |
| | Active component concentration in plant- | | 100 | 0 | 100 | 100 | 100 |
| | vitalizing agent (ppm by mass) | | | | | | |
| Use | Seedling | Exogenous elicitor: | 25% | — | — | — | 100% |
| conditions | stage (4 | chitin oligosaccharide | | | | | |
| | days after | Endogenous elicitor: | 25% | — | — | — | — |
| | germination) | cellooligosaccharide | | | | | |
| | | Xylooligosaccharide | 50% | — | — | — | — |
| | Seedling | Exogenous elicitor: | 25% | — | — | 100% | 100% |
| | stage (18 | chitin oligosaccharide | | | | | |
| | days after | Endogenous elicitor: | 25% | — | — | — | — |
| | germination) | cellooligosaccharide | | | | | |
| | | Xylooligosaccharide | 50% | — | — | — | — |
| | March-April | Exogenous elicitor: | 25% | — | 34% | 100% | 100% |
| | following | chitin oligosaccharide | | | | | |
| | year | Endogenous elicitor: | 25% | — | 33% | — | — |
| | (once/ | cellooligosaccharide | | | | | |
| | 2 weeks) | Xylooligosaccharide | 50% | — | 33% | — | — |

| | | | | | | |
|---|---|---|---|---|---|---|
| Results | Harvest yield per section (hull weight, kg) | 2.62 | 2.18 | 2.24 | 2.25 | 2.29 |

### (4) Cultivation Test 3C (Direct Seeding of Corn) (Examples 18C to 28C and Comparative Examples 10C to 14C)

Fertilization was carried out by a conventional farming method in mid-May when the maximum atmospheric temperature exceeded 25 °C, and corn (Honey Bantam) was seeded in a plowed, soil-crushed and leveled field. A 100 m² field divided into 20 sections was used for the test. The method of seeding was 3 seeds each with a ridge width of 100 cm and a plant spacing of 30 cm, and with thinning to leave one of three when the plant heights reached 10 to 15 cm (15 stocks/section). Other management including fertilization, weeding, irrigation and soil gathering were carried out by conventional farming methods. After silks developed in the ears, all except the uppermost ears were scraped off.

The plant-vitalizing agent dilution was dispersed over the leaf surfaces of the germinated corn seedlings and the plant bodies after the seedling stage, under the conditions shown in Table 3-3.

Aqueous solutions (plant-vitalizing agent dilutions) were prepared to the active component concentrations of plant-vitalizing agent under each condition, with 1.5 kg/section each time, and a procedure of foliar application using a watering can was carried out as shown in Table 3-3, followed by harvesting on the 25th day after flowering when the silks had turned brown and begun to crimp, and the harvest yield per section (weight with husks) was measured. The test results are shown in Table 3-3.

TABLE 3-3

| | | | Ex- | Ex- | Ex- | Ex- | Ex- | Ex- | Ex- | Ex- |
|---|---|---|---|---|---|---|---|---|---|---|
| | | | ample | ample | ample | ample | ample | ample | ample | ample |
| | | | 18C | 19C | 20C | 21C | 22C | 23C | 24C | 25C |
| Plant | | | Corn | Corn | Corn | Corn | Corn | Corn | Corn | Corn |
| | Active component concentration in plant- | | 20 | 20 | 20 | 20 | 20 | 20 | 20 | 100 |
| | vitalizing agent (ppm by mass) | | | | | | | | | |
| Use | Seedling | Exogenous elicitor: | — | 34% | 34% | 34% | — | 25% | 25% | — |
| conditions | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | — | — | 34% | 25% | — | 25% | 34% |
| | stage (18 | chitin oligosaccharide | | | | | | | | |
| | days after | Endogenous elicitor: | 33% | — | — | 33% | 25% | — | 25% | 33% |
| | germination) | cellooligosaccharide | | | | | | | | |
| | | Xylooligosaccharide | 33% | — | — | 33% | 50% | — | 50% | 33% |
| | March-April | Exogenous elicitor: | 34% | 34% | — | 34% | 25% | 25% | 25% | 34% |
| | following | chitin oligosaccharide | | | | | | | | |
| | year | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Harvest yield per section (weight w/husk, kg) | | 6.49 | 6.64 | 6.60 | 6.75 | 6.54 | 6.68 | 6.78 | 6.56 |
| | | | | | | Comp. | Comp. | Comp. | Comp. | Comp. |
| | | | Ex- | Ex- | Ex- | Ex- | Ex- | Ex- | Ex- | Ex- |
| | | | ample | ample | ample | ample | ample | ample | ample | ample |
| | | | 26C | 27G | 28C | 10C | 11C | 12C | 13C | 14C |
| Plant | | | Corn | Corn | Corn | Corn | Corn | Corn | Corn | Corn |
| | Active component concentration in plant- | | 100 | 100 | 100 | 0 | 20 | 20 | 20 | 20 |
| | vitalizing agent (ppm by mass) | | | | | | | | | |
| Use | Seedling | Exogenous elicitor: | 34% | — | 25% | — | — | — | 100% | — |
| conditions | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | | 50% | — | — | — | — | 66% |
| | Seedling | Exogenous elicitor: | 34% | 25% | 25% | — | — | 100% | 100% | — |
| | stage (18 | chitin oligosaccharide | | | | | | | | |
| | days after | Endogenous elicitor: | 33% | 25% | 25% | — | — | — | — | 34% |
| | germination) | cellooligosaccharide | | | | | | | | |
| | | Xylooligosaccharide | 33% | 50% | 50% | — | — | — | — | 66% |
| | March-April | Exogenous elicitor: | 34% | 25% | 25% | — | 34% | 100% | 100% | — |
| | following | chitin oligosaccharide | | | | | | | | |
| | year | Endogenous elicitor: | 33% | 25% | 25% | — | 33% | — | — | 34% |
| | (once/ | cellooligosaccharide | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Harvest yield per section (weight w/husk, kg) | 6.82 | 6.58 | 6.86 | 4.84 | 5.22 | 5.41 | 5.55 | 5.66 |

In addition, the results in Table 3-1 confirmed that harvest yield can be markedly increased during cultivation of rice as a Poaceae plant, if a plant-vitalizing agent including both an exogenous elicitor and an endogenous elicitor is used for seedlings. In addition, the results in Table 3-2 confirmed that harvest yield can be markedly increased during cultivation of wheat as a Poaceae plant, if a plant-vitalizing agent including both an exogenous elicitor and an endogenous elicitor is used for seedlings. In addition, the results in Table 3-3 confirmed that harvest number can be markedly increased during cultivation of corn as a Poaceae plant, if a plant-vitalizing agent including both an exogenous elicitor and an endogenous elicitor is used for seedlings.

### 5. Cultivation of Fabaceae Plants

### (1) Preparation of Plant-Vitalizing Agent

Each oligosaccharide prepared in [1. Preparation of oligosaccharides] was dissolved in water while stirring with a stirrer in a compositional ratio for 1000 times the active component concentration (ppm by mass) in the plant-vitalizing agents of Examples 1D to 15D and Comparative Examples 1D to 9D listed in Table 4-1 to Table 4-2, after which the bacteria were removed with a 0.45 μm filter, to obtain plant-vitalizing agent stock solutions. Each stock solution was diluted 1000-fold with water and used for the following cultivation test. The plant-vitalizing agent obtained by 1000-fold dilution of the stock solution may also be referred to as “plant-vitalizing agent dilution”. The compositional ratios of the oligosaccharides in the tables are represented as mass %.

### (2) Cultivation Test 1D (Examples 1D to 11D and Comparative Examples 1D to 5D)

Commercial seeding soil was placed in a nursery box and thoroughly watered, holes with diameters of 4 to 5 cm and depths of about 2 cm were dug and 3 to 4 soybean (Aoaji Edamame) seeds were sown in each and covered to the same original surface. The covered soil was lightly compacted and thoroughly watered, and left in an environment of 30 °C for germination. The plants were thinned to two stalks when the cotyledons began to open, and at 20 days after seeding the seedlings with 2 to 3 developed true leaves were planted in a field.

The soybean field cultivation was in a vinyl greenhouse, with a total field area of 100 m², and the soybean seedlings were planted in 20 sections with 50 seedlings/section, with ridge widths of 50 cm and spacings of 20 cm, by a conventional agricultural method using chemical fertilizer.

The plant-vitalizing agent dilution was dispersed onto the germinated soybean seedlings and the planted plant bodies after the seedling stage, to wetting of the leaf surfaces and soil, under the conditions shown in Table 4-1.

Aqueous solutions (plant-vitalizing agent dilutions) were prepared to the active component concentrations of plant-vitalizing agent for each condition with 1.5 kg/group each time, and from two weeks after planting, a procedure of foliar application and watering of the soil near the roots using a watering can was carried out once every 2 weeks for 2 months for a total of 5 times, after which the number of pods per stock and the gross pod weight per stock for 50 seedlings (one section) were measured and compared between the different conditions.

The weight per pod was measured by cutting out the pod alone and measuring its weight. The test results are shown in Table 4-1.

TABLE 4-1

| | | | Example | Example | Example | Example | Example | Example | Example | Example |
|---|---|---|---|---|---|---|---|---|---|---|
| | | | 1D | 2 D | 3 D | 4 D | 5 D | 6D | 7D | 8D |
| Plant | | | Soybean | Soybean | Soybean | Soybean | Soybean | Soybean | Soybean | Soybean |
| | | | (Eda- | (Eda- | (Eda- | (Eda- | (Eda- | (Eda- | (Eda- | (Eda- |
| | | | mame) | mame) | mame) | mame) | mame) | mame) | mame) | mame) |
| | Active component concentration in plant- | | 20 | 20 | 20 | 20 | 20 | 20 | 20 | 100 |
| | vitalizing agent (ppm by mass) | | | | | | | | | |
| Use | Seedling | Exogenous elicitor: | — | 34% | 34% | 34% | — | 25% | 25% | — |
| conditions | stage (4 | chitin oligosaccharide | | | | | | | | |
| | days after | Endogenous elicitor: | — | 33% | 33% | 33% | — | 25% | 25% | — |
| | germination) | cellooligosaccharide | | | | | | | | |
| | | Xylooligosaccharide | — | 33% | 33% | 33% | — | 50% | 50% | — |
| | Seedling | Exogenous elicitor: | 34% | — | — | 34% | 25% | — | 25% | 34% |
| | stage (14 | chitin oligosaccharide | | | | | | | | |
| | days after | Endogenous elicitor: | 33% | — | — | 33% | 25% | — | 25% | 33% |
| | germination) | cellooligosaccharide | | | | | | | | |
| | | Xylooligosaccharide | 33% | — | — | 33% | 50% | — | 50% | 33% |
| | 2 months | Exogenous elicitor: | 34% | 34% | — | 34% | 25% | 25% | 25% | 34% |
| | after | chitin oligosaccharide | | | | | | | | |
| | planting | Endogenous elicitor: | 33% | 33% | — | 33% | 25% | 25% | 25% | 33% |
| | (once/ | cellooligosaccharide | | | | | | | | |
| | 2 weeks) | Xylooligosaccharide | 33% | 33% | — | 33% | 50% | 50% | 50% | 33% |
| Results | Pod number per stock (number/stock) | | 31.1 | 32.3 | 31.5 | 33.2 | 31.8 | 33.3 | 35.1 | 34.2 |
| | Gross pod weight per stock (g/stock) | | 71.5 | 74.3 | 72.3 | 80.3 | 70.6 | 78.6 | 82.8 | 75.2 |
| | | | | | | Comp. | Comp. | Comp. | Comp. | Comp. |
| | | | Example | Example | Example | Example | Example | Example | Example | Example |
| | | | 9D | 10D | 11D | 1D | 2D | 3D | 4D | 5D |
| Plant | | | Soybean | Soybean | Soybean | Soybean | Soybean | Soybean | Soybean | Soybean |
| | | | (Eda- | (Eda- | (Eda- | (Eda- | (Eda- | (Eda- | (Eda- | (Eda- |
| | | | mame) | mame) | mame) | mame) | mame) | mame) | mame) | mame) |
| | Active component concentration in plant- | | 100 | 100 | 100 | 0 | 20 | 20 | 20 | 20 |
| | vitalizing agent (ppm by mass) | | | | | | | | | |
| Use | Seedling | Exogenous elicitor: | 34% | — | 25% | — | — | — | 100% | — |
| conditions | stage (4 | chitin oligosaccharide | | | | | | | | |
| | days after | Endogenous elicitor: | 33% | — | 25% | — | — | — | — | 34% |
| | germination) | cellooligosaccharide | | | | | | | | |
| | | Xylooligosaccharide | 33% | — | 50% | — | — | — | — | 66% |
| | Seedling | Exogenous elicitor: | 34% | 25% | 25% | — | — | 100% | 100% | — |
| | stage (14 | chitin oligosaccharide | | | | | | | | |
| | days after | Endogenous elicitor: | 33% | 25% | 25% | — | — | — | — | 34% |
| | germination) | cellooligosaccharide | | | | | | | | |
| | | Xylooligosaccharide | 33% | 50% | 50% | — | — | — | — | 66% |
| | 2 months | Exogenous elicitor: | 34% | 25% | 25% | — | 34% | 100% | 100% | — |
| | after | chitin oligosaccharide | | | | | | | | |
| | planting | Endogenous elicitor: | 33% | 25% | 25% | — | 33% | — | — | 34% |
| | (once/ | cellooligosaccharide | | | | | | | | |
| | 2 weeks) | Xylooligosaccharide | 33% | 50% | 50% | — | 33% | — | — | 66% |

| | | | | | | | | | |
|---|---|---|---|---|---|---|---|---|---|
| Results | Pod number per stock (number/stock) | 36.1 | 34.5 | 37.6 | 27.6 | 29.1 | 29.4 | 30.2 | 30.6 |
| | Gross pod weight per stock (g/stock) | 89.5 | 76.9 | 90.2 | 61.1 | 64.2 | 64.1 | 67.3 | 67.9 |

### (3) Cultivation Test 2D (Examples 12D to 15D and Comparative Examples 6D to 9D)

A test was conducted using Azuki bean (Dainagon) as a Fabaceae plant. For direct seeding in a field, 2 to 3 seeds were seeded at 15 cm spacings and depths of 3 to 4 cm. The covered soil was lightly compacted and thoroughly watered for germination.

The plant-vitalizing agent dilution was dispersed onto the germinated azuki bean seedlings and the plant bodies after the seedling stage, to wetting of the leaf surfaces and soil, under the conditions shown in Table 4-2. The other cultivation conditions were according to conventional farming methods, and final comparison was made based on the number of pods and azuki bean harvest yield per stock. The azuki bean harvest yield was the edible weight per stock after drying and pod removal. The test results are shown in Table 4-2.

TABLE 4-2

| | | | | | | | Comp. | Comp. | Comp. | Comp. |
|---|---|---|---|---|---|---|---|---|---|---|
| | | | Ex- | Ex- | Ex- | Ex- | Ex- | Ex- | Ex- | Ex- |
| | | | ample | ample | ample | ample | ample | ample | ample | ample |
| | | | 12D | 13 D | 14D | 15D | 6D | 7D | 8D | 9D |
| Plant | | | Azuki | Azuki | Azuki | Azuki | Azuki | Azuki | Azuki | Azuki |
| | | | bean | bean | bean | bean | bean | bean | bean | bean |
| Use | Active component concentration in plant- | | 100 | 100 | 100 | 100 | 0 | 100 | 100 | 100 |
| conditions | vitalizing agent (ppm by mass) | | | | | | | | | |
| | Seedling | Exogenous elicitor: | — | 34% | — | 25% | — | — | — | 100% |
| | stage (4 | chitin oligosaccharide | | | | | | | | |
| | days after | Endogenous elicitor: | — | 33% | — | 25% | — | — | — | — |
| | germination) | cellooligosaccharide | | | | | | | | |
| | | Xylooligosaccharide | — | 33% | — | 50% | — | — | — | — |
| | Seedling | Exogenous elicitor: | 34% | 34% | 25% | 25% | — | — | 100% | 100% |
| | stage (14 | chitin oligosaccharide | | | | | | | | |
| | days after | Endogenous elicitor: | 33% | 33% | 25% | 25% | — | — | — | — |
| | germination) | cellooligosaccharide | | | | | | | | |
| | | Xylooligosaccharide | 33% | 33% | 50% | 50% | — | — | — | — |
| | 3 weeks to 2 | Exogenous elicitor: | 34% | 34% | 25% | 25% | — | 34% | 100% | 100% |
| | months after | chitin oligosaccharide | | | | | | | | |
| | germination | Endogenous elicitor: | 33% | 33% | 25% | 25% | — | 33% | — | — |
| | (once/ | cellooligosaccharide | | | | | | | | |
| | 2 weeks) | Xylooligosaccharide | 33% | 33% | 50% | 50% | — | 33% | — | — |

| | | | | | | | | | |
|---|---|---|---|---|---|---|---|---|---|
| Results | Pod number per stock (number/stock) | 39.5 | 41.1 | 40.8 | 42.5 | 34.2 | 35.5 | 36.8 | 36.9 |
| | Azuki bean harvest yield per stock (g/stock) | 40.6 | 42.3 | 41.4 | 44.6 | 33.9 | 34.4 | 35.9 | 36.6 |

The results in Table 4-1 and Table 4-2 confirmed that harvest yield can be markedly increased during cultivation of soybean and azuki bean as Fabaceae plants, if a plant-vitalizing agent including both an exogenous elicitor and an endogenous elicitor is used for seedlings.

### 6. Cultivation of Brassicaceae Plants (Reference Examples 1 to 3)

A test was conducted in the same manner as the plant cultivation tests described above, using komatsuna as a Brassicaceae plant.

Ridges were formed in the composted and plowed field while ensuring ridge spacings of about 15 to 20 cm and the komatsuna (Inamura) seeds were sowed at spacings of 1 to 1.5 cm, and after light soil covering and compaction, they were thoroughly irrigated. The plant-vitalizing agent dilution was dispersed onto the germinated komatsuna seedlings with appropriate thinning to wetting of the leaf surfaces and soil, under the conditions shown in Table 5. Harvesting was carried out when the plant heights reached 20 to 25 cm, and the harvest weights per stock were compared for 20 seedlings. The test results are shown in Table 5.

TABLE 5

| | | | Ref. | Ref. | Ref. |
|---|---|---|---|---|---|
| | | | Example 1 | Example 2 | Example 3 |
| Plant | | | Komatsuna | Komatsuna | Komatsuna |
| | Active component concentration in | | 0 | 20 | 20 |
| | plant-vitalizing agent (ppm by mass) | | | | |
| Use | Seedling stage | Exogenous elicitor: | — | — | 34% |
| conditions | (4 days after | chitin oligosaccharide | | | |
| | germination) | Endogenous elicitor: | — | — | 33% |
| | | cellooligosaccharide | | | |
| | | Xylooligosaccharide | — | — | 33% |
| | Seedling stage | Exogenous elicitor: | — | — | 34% |
| | (4 weeks after | chitin oligosaccharide | | | |
| | germination) | Endogenous elicitor: | — | — | 33% |
| | | cellooligosaccharide | | | |
| | | Xylooligosaccharide | — | — | 33% |
| | 4 weeks after | Exogenous elicitor: | — | 34% | 34% |
| | germination | chitin oligosaccharide | | | |
| | until harvest | Endogenous elicitor: | — | 33% | 33% |
| | (once/2 weeks) | cellooligosaccharide | | | |
| | | Xylooligosaccharide | | 33% | 33% |

| | | | | |
|---|---|---|---|---|
| Results | Harvest weight per stock (g/stock) | 34 | 45 | 46 |

Based on the results in Table 5, no significant increase in weight per stock could be obtained during cultivation of komatsuna as a Brassicaceae plant, even when a plant-vitalizing agent including both an exogenous elicitor and an endogenous elicitor was used for seedlings in addition to the growth phase before harvesting.

1. A method for cultivating a plant comprising
applying a plant-vitalizing agent comprising an exogenous elicitor and an endogenous elicitor at least once to a seedling of the plant,
wherein the exogenous elicitor is a chitin oligosaccharide, and the endogenous elicitor comprises a cellooligosaccharide and xylooligosaccharide, and
the plant is at least one selected from the group consisting of plants of the families Solanaceae, Cucurbitaceae, Poaceae and Fabaceae.

2. The method for cultivating a plant according to claim 1, wherein the mass ratio of the exogenous elicitor with respect to the endogenous elicitor in the plant-vitalizing agent is 0.1 to 5.

3. The method for cultivating a plant according to claim 1, wherein the mass ratio of the cellooligosaccharide with respect to the xylooligosaccharide in the plant-vitalizing agent is 0.2 to 5.

4. The method for cultivating a plant according to claim 1, wherein the method comprises applying a plant-vitalizing agent to a seedling of the plant at least once at 2 to 15 days after germination.

5. The method for cultivating a plant according to claim 1, wherein the method comprises applying a plant-vitalizing agent to a plant body at least once after the seedling stage.

6. The method for cultivating a plant according to claim 1, wherein the plant is a Solanaceae plant.

7. The method for cultivating a plant according to claim 9, wherein the Solanaceae plant is at least one selected from the group consisting of tomato, potato and bell pepper.

8. The method for cultivating a plant according to claim 1, wherein the plant is a Cucurbitaceae plant.

9. The method for cultivating a plant according to claim 8, wherein the Cucurbitaceae plant is at least one selected from the group consisting of watermelon and cucumber.

10. The method for cultivating a plant according to claim 6, wherein the seedling is a scion for grafted seedling growth.

11. The method for cultivating a plant according to claim 1, wherein the plant is a Poaceae plant.

12. The method for cultivating a plant according to claim 11, wherein the Poaceae plant is at least one selected from the group consisting of rice, wheat, barley, corn and sugarcane.

13. The method for cultivating a plant according to claim 1, wherein the plant is a Fabaceae plant.

14. The method for cultivating a plant according to claim 13, wherein the Fabaceae plant is at least one selected from the group consisting of soybean and azuki bean.

15. The method for cultivating a plant according to claim 1, which comprises applying the plant-vitalizing agent to a plant at a concentration so that the total content of the exogenous elicitor and the endogenous elicitor is 0.1 to 500 ppm by mass.

16. The method for cultivating a plant according to claim 1, which comprises applying the plant-vitalizing agent to a plant by foliar application.

17. A plant-vitalizing agent comprising an exogenous elicitor and an endogenous elicitor comprising cellooligosaccharide and a xylooligosaccharide, to be used for cultivation of at least one plant selected from the group consisting of plants of the families Solanaceae, Cucurbitaceae, Poaceae and Fabaceae, which is applied at least one time to a seedling of the plant.
